(19) United States
(12) Patent Application Publication
(10) Pub. No.: US 2025/0261248 A1
(43) Pub. Date: Aug. 14, 2025

(54) COMMUNICATION SYSTEMS, APPARATUSES, METHODS, AND NON-TRANSITORY COMPUTER-READABLE STORAGE DEVICES FOR UPLINK PREAMBLE TRANSMISSION AND RECEPTION

(71) Applicant: Huawei Technologies Co., Ltd., Shenzhen (CN)

(72) Inventors: Abdelmalik Nasser Ali Aljalai, Ottawa (CA); Amine Maaref, Ottawa (CA)

(21) Appl. No.: 19/175,614

(22) Filed: Apr. 10, 2025

Related U.S. Application Data
(63) Continuation of application No. PCT/CN2022/125172, filed on Oct. 13, 2022.

(51) Int. Cl. H04W 74/0833

(52) U.S. Cl. CPC H04W 74/0833

(57) ABSTRACT

Communication systems, apparatuses, methods, and one or more non-transitory computer-readable storage devices for physical random-access channel (PRACH) signaling and detection using a random-access preamble are provided. The random-access preamble has a modified sequence obtained from a first Zadoff-Chu (ZC) sequence rotated by an angle θ and scaled by a scaling factor R. In some embodiments, the random-access preamble may also have a second ZC sequence.

### CROSS-REFERENCE TO RELATED APPLICATION

This application is a continuation of International Application No. PCT/CN2022/125172, filed on Oct. 13, 2022, titled “COMMUNICATION SYSTEMS, APPARATUSES, METHODS, AND NON-TRANSITORY COMPUTER-READABLE STORAGE DEVICES FOR UPLINK PREAMBLE TRANSMISSION AND RECEPTION,” which is hereby incorporated by reference in its entirety.

### FIELD OF THE DISCLOSURE

The present disclosure relates generally to communication systems, apparatuses, methods, and non-transitory computer-readable storage devices, and in particular to communication systems, apparatuses, methods, and non-transitory computer-readable storage devices for uplink preamble transmission and reception.

### Acronym Key and Definitions of Some Technical Terms

For ease of reading, subsections C and D of the Detailed Description list the acronyms and definitions of some technical terms used in this disclosure.

### BACKGROUND

Mobile communication systems are known. While most mobile communication systems are so-called terrestrial network (TN) systems (which generally comprise a plurality of transmit-receive points (TRPs) deployed on the ground), non-terrestrial network (NTN) systems (which generally comprise a plurality of non-terrestrial TRPs such as satellites and high altitude platform stations (HAPS) deployed above ground or in the space) are also deployed or have started their deployment in recent years.

In mobile wireless communication systems such as fourth generation (4G) and fifth generation (5G) mobile wireless communication systems, user equipments (UEs) use a process known as random access to communicate with a TRP via a shared wireless-communication channel. In a random access process, physical random-access channel (PRACH) sequences are often used to establish uplink synchronization between a UE and a TRP by determining the carrier frequency offset (CFO) and the time delay (TD) therebetween. In 5G new radio (NR), the TRP and UE use Zadoff-Chu (ZC) sequences as the PRACH sequences to establish the uplink synchronizations therebetween.

Unlike TRPs of the TN systems where TRPs are at fixed locations, the TRPs of NTN systems are often movable. The TRPs' speeds of movements in NTN depends on the type of implementation, and in many applications such as those using low-earth satellites as the TRPs, the satellites or TRPs move at high speeds which may result in large Doppler shifts represented by large CFOs in the signals received at the TRPs. Moreover, compared to the TN systems, the cell size in NTN systems is relatively large which may result in large differential TDs between edge UEs (that is, UEs around the edge of a TRP cell or the edge of a TRP beam) and central UEs (that is, UEs around the center of the a TRP cell or the edge of the TRP beam) that belong to the same TRP cell or served by the same TRP beam. Moreover, the large distance between UEs and the TRPs may cause high propagation round-trip delay (RTD) which may require long cyclic prefix. In addition, the TRPs in NTN systems usually have a power capacity limitation, which generally requires low-power computational algorithms and fast computational algorithms at the same time.

### SUMMARY

Embodiments of this disclosure relate to communication systems, apparatuses, methods, and one or more non-transitory computer-readable storage devices for physical random-access channel (PRACH) signaling and detection using a PRACH preamble. Embodiments of this disclosure may solve or mitigate the aforementioned problems associated with NTN random access.

More particularly, embodiments of the present disclosure employ modified ZC sequences including a rotation parameter, which may provide improved detection performance, estimation accuracy, and/or lower complexity implementation as compared to conventional solutions for NTN random access.

According to one aspect of this disclosure, there is provided a first method comprising: transmitting a physical random-access channel (PRACH) preamble comprising at least a modified sequence generated from a first Zadoff-Chu (ZC) sequence rotated by an angle θ, the first ZC sequence belonging to a set of ZC sequences.

In some embodiments, the first method further comprises: receiving the angle θ via radio resource control (RRC) signaling.

In some embodiments, the modified sequence is the first ZC sequence rotated by the angle θ and scaled by a scaling factor R.

In some embodiments, the first method further comprises: receiving the scaling factor R via the RRC signaling.

In some embodiments, 0<R≤1.

In some embodiments, θ=π/2.

In some embodiments, the first ZC sequence is randomly selected from the set of ZC sequences.

In some embodiments, the PRACH preamble further comprises a second ZC sequence.

In some embodiments, the second ZC sequence is randomly selected from the set of ZC sequences.

In some embodiments, the first and second ZC sequences are ZC sequences of different roots.

In some embodiments, the first ZC sequence is a complex conjugate of the second ZC sequence.

In some embodiments, the PRACH preamble comprises a superimposed PRACH sequence being a superimposition of the modified sequence and the second ZC sequence.

In some embodiments, said transmitting the PRACH preamble comprises:
transmitting the modified sequence and the second ZC sequence using a same communication resource or using different communication resources.

In some embodiments, the PRACH preamble comprises a first and a second copies of the superimposed PRACH sequence; and the first and the second copies sandwich a cyclic prefix (CP) therebetween.

In some embodiments, the first and the second copies further sandwich a guard interval therebetween.

In some embodiments, the PRACH preamble comprises a first and a second copies of the superimposed PRACH sequence; and the second copy is directly concatenated to the first copy.

According to one aspect of this disclosure, there is provided a user equipment comprising: a memory; a transmitter; and a processing unit functionally coupled to the memory and the transmitter for performing the above-described first method.

According to one aspect of this disclosure, there is provided one or more non-transitory computer-readable storage devices comprising computer-executable instructions, wherein the instructions, when executed, cause a processing unit of the user equipment to perform the above-described first method.

According to one aspect of this disclosure, there is provided a second method comprising: receiving a PRACH preamble; determining from the PRACH preamble at least a modified sequence, the modified sequence being a first ZC sequence rotated by an angle θ, the first ZC sequence belonging to a set of ZC sequences; and estimating at least one of a time delay (TD) and a carrier frequency offset (CFO) based on the PRACH preamble and the modified sequence for establishing uplink synchronization with the UE.

In some embodiments, the second method further comprises: transmitting the angle θ via RRC signaling.

In some embodiments, the modified sequence is the first ZC sequence rotated by the angle θ and scaled by a scaling factor ρ.

In some embodiments, the second method further comprises: transmitting a scaling factor R via the RRC signaling, the scaling factor ρ corresponding to the scaling factor R.

In some embodiments, 0<ρ≤1.

In some embodiments, θ=π/2.

In some embodiments, said determining from the PRACH preamble at least the modified sequence comprises: determining from the PRACH preamble the modified sequence and a second ZC sequence.

In some embodiments, the first and second ZC sequences are ZC sequences of different roots.

In some embodiments, the first ZC sequence is a complex conjugate of the second ZC sequence.

In some embodiments, the PRACH preamble comprises a superimposed PRACH sequence being a summation of the modified sequence and the second ZC sequence.

In some embodiments, said determining from the PRACH preamble at least the modified sequence comprises: obtaining at least a candidate modified sequence based on the set of ZC sequences; calculating a candidate PRACH sequence at least based on the candidate modified sequence; calculating a cross-correlation between the candidate PRACH sequence and the superimposed PRACH sequence; using a correlation peak detection method to detect one or more peaks of the cross-correlation greater than other values thereof by at least a threshold value; and determining at least the modified sequence as the candidate modified sequence.

In some embodiments, said using the correlation peak detection method to detect the one or more peaks of the cross-correlation greater than the other values thereof by the at least threshold value comprises: using the correlation peak detection method to detect one peak of the cross-correlation greater than other values thereof by the at least threshold value; and said estimating the TD and/or the CFO based on the PRACH preamble and the modified sequence comprises: estimating the TD based on the detected peak.

In some embodiments, said using the correlation peak detection method to detect the one or more peaks of the cross-correlation greater than the other values thereof by the at least threshold value comprises: using the correlation peak detection method to detect a plurality of peaks of the cross-correlation greater than other values thereof by the at least threshold value; and said estimating the TD and/or the CFO based on the PRACH preamble and the modified sequence comprises: estimating the TD and the CFO based on the detected peaks.

In some embodiments, said obtaining at least the candidate modified sequence based on the set of ZC sequences comprises: obtaining at least the candidate modified sequence and a second candidate ZC sequence based on the set of ZC sequences; said calculating the candidate PRACH sequence at least based on the candidate modified sequence comprises: calculating the candidate PRACH sequence based on the candidate modified sequence and the second candidate ZC sequence; and said determining at least the modified sequence as the candidate modified sequence comprises: determining the modified sequence and the second ZC sequence as the candidate modified sequence and the second candidate ZC sequence, respectively.

In some embodiments, said determining from the PRACH preamble at least the modified sequence comprises: obtaining a candidate modified sequence and a second candidate ZC sequence based on a set of ZC sequences; calculating a first cross-correlation between the superimposed PRACH sequence and the modified ZC sequence; calculating a second cross-correlation between the superimposed PRACH sequence and the second candidate ZC sequence; and using a correlation peak detection method to detect one or more peaks of the first and second cross-correlations respectively greater than other values thereof by at least a threshold value; and determining the modified sequence and the second ZC sequence as the candidate modified sequence and the second candidate ZC sequence, respectively.

In some embodiments, said determining from the PRACH preamble at least the modified sequence comprises: determining the modified sequence and the second ZC sequence from a first PRACH sequence and a second PRACH sequence, respectively, the first and second PRACH sequences being detected from different communication resources of the PRACH preamble.

In some embodiments, said determining from the PRACH preamble at least the modified sequence comprises: obtaining a candidate modified sequence and a second candidate ZC sequence based on a set of ZC sequences; calculating a first cross-correlation between the first PRACH sequence and the candidate modified sequence; calculating a second cross-correlation between the second PRACH sequence and the second candidate sequence; and using a correlation peak detection method to detect one or more peaks of the first and second cross-correlations respectively greater than other values thereof by at least a threshold value; and determining the modified sequence and the second ZC sequence as the candidate modified sequence and the second candidate ZC sequence, respectively.

In some embodiments, said obtaining at least the candidate modified sequence based on the set of ZC sequences comprises: selecting the second candidate ZC sequence from the set of ZC sequences; and calculating the candidate modified sequence as a complex conjugate of the second candidate ZC sequence, rotated by the angle θ and scaled by the scaling factor ρ.

In some embodiments, said obtaining at least the candidate modified sequence based on the set of ZC sequences comprises: selecting a first candidate ZC sequence from the set of ZC sequences; selecting the second candidate ZC sequence from the set of ZC sequences; and calculating the candidate modified sequence as the first candidate ZC sequence rotated by the angle θ and scaled by the scaling factor ρ.

According to one aspect of this disclosure, there is provided an apparatus comprising: a memory; a transmitter; and a processing unit functionally coupled to the memory and the transmitter for performing the above-described second method.

According to one aspect of this disclosure, there is provided one or more non-transitory computer-readable storage devices comprising computer-executable instructions, wherein the instructions, when executed, cause a processing unit of the user equipment to perform the above-described second method.

According to one aspect of this disclosure, there is provided a system comprising a first apparatus and a second apparatus. The first apparatus is configured to receive a random-access preamble. The first apparatus is further configured to transmit, based on the received random-access preamble, an indication of at least one of a time delay (TD) value or a carrier frequency offset (CFO) value. The second apparatus is configured to transmit the random-access preamble to the first apparatus. The second apparatus is further configured to receive the indication of at least one of the TD value or the CFO value from the first apparatus. The second apparatus is further configured to communicate with the first apparatus in accordance with at least one of the TD value or the CFO value.

Thus the technical features and benefits of the communication systems, apparatuses, methods, and one or more non-transitory computer-readable storage devices disclosed herein in various embodiments may include, but are not limited to:
Providing two linearly independent measurements as the inputs of the estimator, which improves the estimation accuracy of TD and/or CFO;
Using a single root to generate the ZC sequence and its complex conjugate, which simplifies the receiver circuitry and PRACH detection at the TRP 102;
Enabling detection of large CFOs in various environments (such as up to half of the used PRACH bandwidth), which facilitates the establishment of uplink synchronization between the UE and the TRP;
The design parameter R, wherein, when R=0, the above-described PRACH preamble having modified ZC sequences and related PRACH-signaling and PRACH-detection procedures may operate for TN systems or the terrestrial TRPs, which provides backward compatible with NR;
The tunable design parameters R and θ, which facilitate adapting of various communications environments;
Having a rotational angle that eliminates the ambiguity and adds an independency to the components of PRACH preamble, which may be used instead of using two non-complex conjugate PRACH preambles with different roots for the same UE, thereby giving the TRP the capability to efficiently use the allocated PRACH preambles to simultaneously serve a large number of UEs, as the number of PRACH sequences per UE is minimized.
Providing an ability to control the PAPR at UEs using R and θ to select the minimum optimal PAPR. At the TRP, the receiver thereof may only use one root to generate the ZC sequence with its complex conjugate and subsequently their cyclically shifted versions, which minimizes the number of correlation operations and consequently reduces the computational complexity, thereby improving the energy efficiency in both UEs (through lowering the PAPRs) and at TRPs (through lowered receiver complexity with a fast searching algorithm);
Option of transmitting the PRACH preamble using the PRACH sequence and its complex conjugate on same time and frequency resources with the capability to estimate TD and/or CFO, thereby preserving time/frequency resources and improving the PRACH occasions utilizations;
Having a concatenated sequential version either on the same or different PRACH occasions, thereby expanding the ability to accommodate multiple communications configurations and also ensuring orthogonality.

### BRIEF DESCRIPTION OF THE DRAWINGS

FIG. 1 is a simplified schematic diagram showing the structure of a communication system, according to some embodiments of this disclosure;

FIG. 2 is a simplified schematic diagram of a controlling device of a communication network of the communication system shown in FIG. 1;

FIG. 3 is a simplified schematic diagram of a transmit-receive point (TRP) of the communication system shown in FIG. 1;

FIG. 4 is a simplified schematic diagram of a user equipment (UE) of the communication system shown in FIG. 1;

FIG. 5 is a plot showing the ambiguity cross-correlation function of the PRACH preamble when both time delay (TD) and integer carrier frequency offset (CFO) exist between the TRP and UE of a conventional wireless communication system;

FIG. 6 is a flowchart showing a physical random-access channel (PRACH) signaling procedure executed by a UE of the communication system shown in FIG. 1 for uplink PRACH preamble transmission, wherein the PRACH preamble comprises modified Zadoff-Chu (ZC) sequences;

FIG. 7 is a flowchart showing a PRACH-detection procedure executed by a TRP of the communication system shown in FIG. 1 corresponding to the PRACH-signaling procedure shown in FIG. 6;

FIG. 8 is a diagram showing the sequence of operations performed by the UE and the TRP of the communication system shown in FIG. 1 for establishing the uplink synchronization therebetween according to the PRACH-signaling procedure shown in FIG. 6 and the PRACH-detection procedure shown in FIG. 7;

FIG. 9A is a flowchart showing the PRACH-signaling procedure shown in FIG. 6 with the detail of the sequence-generation step, according to some embodiments of this disclosure;

FIG. 9B is a flow diagram showing some steps of the PRACH-signaling procedure shown in FIG. 9A;

FIG. 10A is a flowchart showing the PRACH-detection procedure shown in FIG. 7 corresponding to the PRACH-signaling procedure shown in FIG. 9A, according to some embodiments of this disclosure;

FIG. 10B is a flow diagram showing some steps of the PRACH-detection procedure shown in FIG. 10A;

FIG. 11 is a plot showing the magnitudes of the non-peak terms of the output of the correlator used in a prior-art PRACH-detection method and in the PRACH-detection procedure shown in FIG. 10A;

FIG. 12A is a flowchart showing the PRACH-detection procedure shown in FIG. 7 corresponding to the PRACH-signaling procedure shown in FIG. 9A, according to some embodiments of this disclosure;

FIG. 12B is a flow diagram showing some steps of the PRACH-detection procedure shown in FIG. 12A;

FIGS. 13 and 14 are plots showing the magnitudes of the non-peak terms of the output of the correlators used in the PRACH-detection procedure shown in FIG. 12A;

FIG. 15A is a flowchart showing the PRACH-signaling procedure shown in FIG. 6 with the detail of the sequence-generation step, according to some embodiments of this disclosure;

FIG. 15B is a flow diagram showing some steps of the PRACH-signaling procedure shown in FIG. 15A;

FIG. 16A is a flowchart showing the PRACH-detection procedure shown in FIG. 7 corresponding to the PRACH-signaling procedure shown in FIG. 15A, according to some embodiments of this disclosure;

FIG. 16B is a flow diagram showing some steps of the PRACH-detection procedure shown in FIG. 16A;

FIG. 17A is a flowchart showing the PRACH-signaling procedure shown in FIG. 6 with the detail of the sequence-generation step, according to some embodiments of this disclosure;

FIG. 17B is a flow diagram showing some steps of the PRACH-signaling procedure shown in FIG. 17A;

FIG. 18A is a flowchart showing the PRACH-detection procedure shown in FIG. 7 corresponding to the PRACH-signaling procedure shown in FIG. 17A, according to some embodiments of this disclosure;

FIG. 18B is a flow diagram showing some steps of the PRACH-detection procedure shown in FIG. 18A;

FIG. 19A is a flowchart showing the PRACH-detection procedure shown in FIG. 7 corresponding to the PRACH-signaling procedure shown in FIG. 17A, according to some embodiments of this disclosure;

FIG. 19B is a flow diagram showing some steps of the PRACH-detection procedure shown in FIG. 19A;

FIG. 20A is a flowchart showing the PRACH-signaling procedure shown in FIG. 6 with the detail of the sequence-generation step, according to some embodiments of this disclosure;

FIG. 20B is a flow diagram showing some steps of the PRACH-signaling procedure shown in FIG. 20A;

FIG. 21A is a flowchart showing the PRACH-detection procedure shown in FIG. 7 corresponding to the PRACH-signaling procedure shown in FIG. 20A, according to some embodiments of this disclosure;

FIG. 21B is a flow diagram showing some steps of the PRACH-detection procedure shown in FIG. 21A;

FIG. 22A is a schematic diagram showing a PRACH preamble with two copies of a PRACH sequence having modified ZC sequences, wherein the two copies of a PRACH sequence are concatenated in a sequential manner;

FIG. 22B is a schematic diagram showing a PRACH preamble with two copies of a PRACH sequence having modified ZC sequences, wherein the two copies of a PRACH sequence are concatenated in an aggregated manner;

FIG. 23 is a plot showing a comparison of the constellations of the entries of a conventional ZC sequence, the rotated complex-conjugate of the conventional ZC sequence, and a superimposed PRACH sequence having modified ZC sequences; and

FIG. 24 is a plot showing a comparison of the constellations of a conventional ZC sequence, the rotated complex-conjugate of the conventional ZC sequence, a prior-art PRACH signaling and detection method using two ZC sequences, and a superimposed PRACH sequence having modified ZC sequences.

### DETAILED DESCRIPTION

### A. System Structure

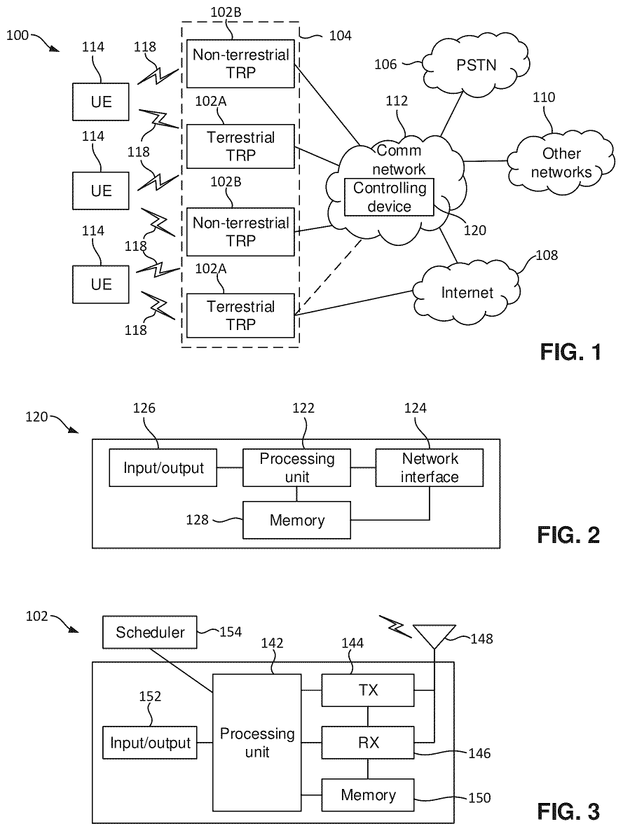

Turning now to FIG. 1, a communication system is shown and is generally identified using reference numeral 100. As shown, the communication system 100 comprises a plurality of transmit-receive points (TRPs) 102 forming a radio access network (RAN) 104 in communication with a plurality of user equipments (UEs) 114 for providing wireless communication services to the UEs 114 such that the UEs 114 may access one or more public switched telephone networks (PSTNs) 106, the Internet 108, and other networks 110 via a communication network 112 to make phone calls (to, for example, other UEs 114, landline phones (not shown), and/or the like), exchanging data (for example, sending/receiving emails, sending/receiving instant messages, and/or the like), accessing contents (such as text content, audio content, and/or video content), and/or the like. Herein, a TRP 102 may also be referred to as a communication node, a gNodeB (next generation node of base station (NodeB), also called a “gigabit” NodeB or a “gNB”), a base station, an access point, and/or the like, and may comprise a plurality of terrestrial TRPs 102A and a plurality of non-terrestrial TRPs 102B (for example, satellite, high altitude platforms stations, unmanned aerial vehicles, and/or the like).

The PSTN 106, in addition to packet switched, may include circuit switched telephone networks for providing plain old telephone service (POTS). The Internet 108 may include a network of computers and subnets (intranets) or both, and incorporate protocols, such as IP, TCP, UDP, and/or the like.

The communication network 112 comprises one or more controlling devices 120 in communication with the TRPs 102 to provide various services such as voice, data, and other services to the UEs 114. The one or more controlling devices 120 of the communication network 112 may also serve as a gateway access between (i) the TRPs 102 or UEs 114 or both, and (ii) other networks (such as the PSTN 106, the Internet 108, and the other networks 110).

FIG. 2 is a simplified schematic diagram of the controlling device 120. As shown, the controlling device 120 comprises at least one processing unit 122 (also denoted “processor”), at least one network interface 124, one or more input/output components or interfaces 126, and at least one memory 128 (also denoted “storage device” hereinafter).

The processing unit 122 is configured for performing various processing operations and may comprise a microprocessor, a microcontroller, a digital signal processor, a field programmable gate array (FPGA), an application specific integrated circuit (ASIC), and/or the like.

The network interface 124 comprises a circuitry for directly or indirectly (that, via one or more intermediate devices) communicating with other devices such as the TRPs 102, the PSTN 106, the Internet 108, and other networks 110 using suitable wired or wireless communication technologies and suitable protocols.

Each input/output component 126 enables interaction with a user or other devices in the communication system 100. Each input/output device 126 may comprise any suitable structure for providing information to or receiving information from a user and may be, for example, a speaker, a microphone, a keypad, a keyboard, a display, a touch screen, and/or the like.

Each memory 128 may comprise any suitable volatile and/or non-volatile storage and retrieval components such as random access memory (RAM), read only memory (ROM), hard disk, optical disc, subscriber identity module (SIM) card, solid-state memory modules, memory stick, secure digital (SD) memory card, and/or the like. The memory 128 may be used for storing instructions executable by the processing unit 122 and data used, generated, or collected by the processing unit 122 and/or the network interface 124. For example, the memory 126 may store software instructions or modules executable by the processing unit 122 for implementing some or all of the functionalities and/or embodiments of the controlling device 120 described herein. The memory 126 may also store coverage information of the TRPs 102 (described in more detail later) in, for example, a database thereof.

Referring back to FIG. 1, the TRPs 102 comprise a plurality of terrestrial TRPs 102A and a plurality of non-terrestrial TRPs 102B. Herein, a terrestrial TRP 102A is generally deployed on the ground (including on ground-based infrastructures such as buildings, towers, and/or the like). The terrestrial TRP 102A may typically comprise a plurality of components such as one or more transmitters and receivers, one or more base station controllers (BSCs), radio network controllers (RNCs), relay nodes, elements, and/or the like. Each terrestrial TRP 102A (or more specifically the base station thereof) transmits and/or receives wireless signals within a particular geographic region or area (that is, a “cell” or a “coverage area”). A cell may be further partitioned into cell sectors, and a terrestrial TRP 102A may, for example, employ multiple transceivers to provide service to multiple cell sectors. In some embodiments, there may be established pico or femto cells where the radio access technology supports such. In some embodiments, multiple transceivers may be used for each cell, for example using multiple-input multiple-output (MIMO) technology.

As those skilled in the art understand, cellular coverage (that is, the coverage of the terrestrial TRPs 102A) typically varies depending on the regions. For example, cellular coverage is typically strong and widely available in regions with dense cellular infrastructure deployment; examples of such regions may be urban regions with high population density where carriers are more willing to deploy more cellular infrastructure. On the other hand, cellular coverage may be sparse and poorly available in regions with sparse cellular infrastructure deployment; examples of such regions may be rural or remote regions with low population density where carriers are less motivated to deploy cellular infrastructure.

On the other hand, a non-terrestrial TRP 102B is a TRP generally deployed above ground or in the space such as a communication satellite or a high altitude platform stations (HAPS) (for example, a drone, a balloon, an airship, an aircraft, or the like). In various embodiments, a non-terrestrial TRP 102B may be permanently or semi-permanently deployed (such as a non-terrestrial TRP 102B in the form of a communication satellite, a communication balloon or airship anchored at a fixed location, or the like), or may be temporarily deployed (for example, a non-terrestrial TRP 102B in the form of a drone, a balloon, or an airship temporarily deployed about a location) for supporting an anticipated intensive-communication event such as a concert, a game, or the like, wherein the deployment of the non-terrestrial TRP 102B may be cancelled after the event.

The terrestrial TRP 102A and non-terrestrial TRP 102B may have a similar structure although they may be different in some aspects such as their communication bandwidths, power units, communication technologies, protocols, and/or the like. FIG. 3 is a simplified schematic diagram of a TRP 102. As shown, the TRP 102 comprises at least one processing unit 142, at least one transmitter 144, at least one receiver 146, one or more antennas 148, at least one memory 150, and one or more input/output components or interfaces 152. A scheduler 154 may be coupled to the processing unit 142. The scheduler 154 may be included within or operated separately from the TRP 102.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like.

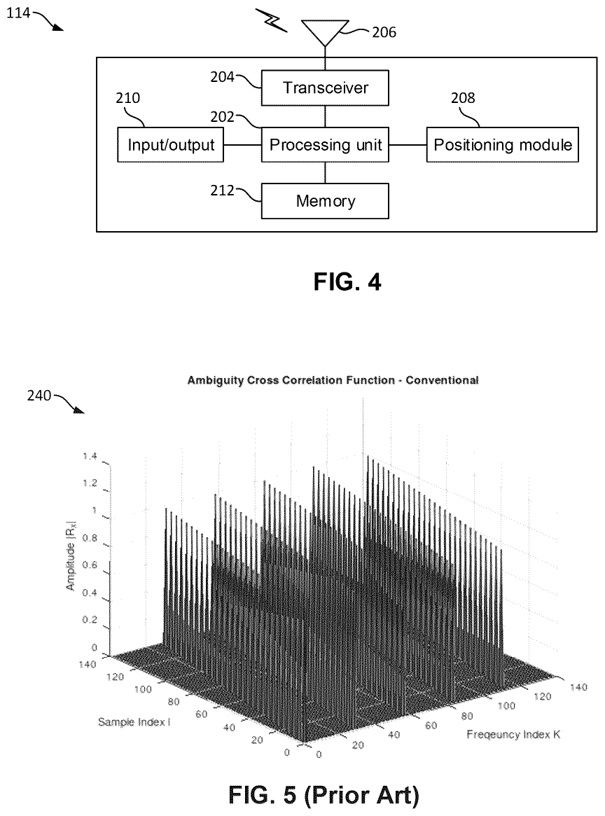

Each transmitter 144 may comprise any suitable structure for generating signals for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 4 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage and retrieval components such as RAM, ROM, hard disk, optical disc, SIM card, solid-state memory modules, memory stick, SD memory card, and/or the like. The memory 150 may be used for storing instructions executable by the processing unit 142 and data used, generated, or collected by the processing unit 142. For example, the memory 150 may store software instructions or modules executable by the processing unit 142 for implementing some or all of the functionalities and/or embodiments of the TRP 102 described herein.

Each input/output component 152 enables interaction with a user or other devices in the system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 1, the TRPs 102 may communicate with the UEs 114 over one or more air interfaces 118 using any suitable wireless communication links such as radio frequency (RF), microwave, infrared (IR), and/or the like. The air interfaces 118 may utilize any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The air interfaces 118 may use any suitable radio access technologies such as universal mobile telecommunication system (UMTS), high speed packet access (HSPA), HSPA+ (optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for GSM evolution (EDGE), GSM EDGE radio access network (GERAN), 5G New Radio (NR), standard or non-standard satellite internet access technologies, and/or the like. Moreover, the communication system 100 may use multiple channel access functionality. Of course, other multiple access schemes and wireless protocols may be used.

Herein, a UE 114 generally refers to a wireless device that may join the communication system 100 via a joint initial access procedure (described in more detail later). In various embodiments, a UE 114 may be a wireless device used by a human or user (such as a smartphone, a cellphone, a personal digital assistant (PDA), a laptop, a computer, a tablet, a smart watch, a consumer electronics device, and/or the like. A UE 114 may alternatively be a wireless sensor, an Internet-of-things (IoT) device, a robot, a shopping cart, a vehicle, a smart TV, a smart appliance, or the like. Depending on the implementation, the UE 114 may be movable autonomously or under the direct or remote control of a human, or may be positioned at a fixed position. In some embodiments, a UE 114 may be a network device (such as a TRP 102, a wireless transmit/receive unit (WTRU), a mobile station, a fixed or mobile subscriber unit, a machine type communication (MTC) device, a device of the communication network 112, or the like) which is considered as a UE when it is powered on and joins the communication system 100 via the joint initial access procedure; and then acts as a network device after the joint initial access procedure is completed). In some embodiments, the UEs 114 may be multimode devices capable of operation according to multiple radio access technologies and incorporate multiple transceivers necessary to support such.

FIG. 4 is a simplified schematic diagram of a UE 114. As shown, the UE 114 comprises at least one processing unit 202, at least one transceiver 204, at least one antenna or network interface controller (NIC) 206, at least one positioning module 208, one or more input/output components 210, and at least one memory 212.

The processing unit 202 is configured for performing various processing operations such as signal coding, data processing, power control, input/output processing, or any other functionalities to enable the UE 114 to join the communication system 100 and operate therein. The processing unit 202 may also be configured to implement some or all of the functionalities and/or embodiments of the UE 114 described in this disclosure. The processing unit 202 may comprise a microprocessor, a microcontroller, a digital signal processor, a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like.

The at least one transceiver 204 may be configured for modulating data or other content for transmission by the at least one antenna 206. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning anchors. The positioning module 208 may use the transceiver 204 and antenna 206 for communicating with the positioning anchors, or may comprise separate transceiver and antenna for communicating with the positioning anchors. In some embodiments, the positioning anchors may be positioning devices such as navigation satellites and/or HAPS separated from the non-terrestrial TRPs 102B. For example, the navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning anchors may be devices (for example, navigation satellites and/or HAPS) acting as both positioning anchors for providing positioning reference signals and as non-terrestrial TRPs 102B.

The one or more input/output components 210 is configured for interaction with a user or other devices in the system 100. Each input/output component 210 may comprise any suitable structure for providing information to or receiving information from a user and may be, for example, a speaker, a microphone, a keypad, a keyboard, a display, a touch screen, a network communication interface, and/or the like.

The at least one memory 212 is configured for storing instructions executable by the processing unit 202 and data used, generated, or collected by the processing unit 202. For example, the memory 212 may store software instructions or modules executable by the processing unit 202 for implementing some or all of the functionalities and/or embodiments of the UE 114 described herein. Each memory 212 may comprise any suitable volatile and/or non-volatile storage and retrieval components such as AM, ROM, hard disk, optical disc, SIM card, solid-state memory modules, memory stick, SD memory card, and/or the like.

For ease of description, in the following, a communication system 100 having one or more terrestrial TRPs 102A without any non-terrestrial TRPs 102B is denoted a terrestrial network (TN) system, and a communication system 100 having one or more non-terrestrial TRPs 102B is denoted a non-terrestrial network (NTN) system. Those skilled in the art will appreciate that an NTN system 100 may also comprise one or more terrestrial TRPs 102A. Moreover, while an NTN system 100 is described as an example in the following description, those skilled in the art will appreciate that the methods describe below may also be used for TN systems, and/or the terrestrial TRPs 102A of NTN systems. Thus, in the following description, the terms “TN” and “terrestrial TRP” may be used interchangeably in that a feature, characteristic, or method described for a TN system may be applicable for a terrestrial TRP 102A (regardless whether the terrestrial TRP102A is in a terrestrial network system or in a non-terrestrial network system). Similarly, the terms “NTN” and “non-terrestrial TRP” may be used interchangeably in that a feature, characteristic, or method described for an NTN system may be applicable for a non-terrestrial TRP 102B.

### B. Physical Random-Access Channel (PRACH)

As those skilled in the art will appreciate, the communication system 100 may operate by sharing resources such as bandwidth, and allow data transmission (for example, transmission of voice, data, video, text, and/or the like) via broadcast (one device to all devices in the system 100; that is, one-to-all), multicast (one device to a plurality of device; that is, one-to-many), unicast (one device to another device such as one UE 114 to another UE; that is, one-to-one), and/or the like.

In the communication system 100, a UE 114 generally needs to execute an initial access procedure to establish a “connection” (that is, to establish communication) with a TRP 102 for joining the network system for communicating with other components thereof such as other UEs 114, the communication network 104, the PSTNs 104, the Internet 106, and other networks 108. The purpose of the initial access procedure is for the UE 114 to acquire downlink and uplink synchronization with the TRP 102.

For example, the initial access procedure defined since LTE comprises four physical-layer steps: (i) cell search, (ii) cell selection, (iii) system information acquisition, and (iv) random access. Initial access is typically initiated when the UE 114 is in the IDLE state or the INACTIVE state. After performing the initial access procedure, the UE 114 then transitions from the IDLE or INACTIVE states to the CONNECTED state. Upon completing the initial access procedure, the UE 114 is considered to have acquired both downlink and uplink synchronization with the TRP 102.

UEs 114 usually use random access to communicate with a TRP 102 via a shared wireless-communication channel. In the initial access procedure, physical random-access channel (PRACH) signals are used for transmitting random-access preambles (also denoted “PRACH preambles”) from the UEs 114 to the TRP 102 for initiation of random access. A PRACH preamble is a type of an orthogonal frequency-division multiplexing (OFDM) signal (which has a plurality of subcarriers with predefined subcarrier spacing) and generally comprises a cyclic prefix, a PRACH sequence generated based on Zadoff-Chu (ZC) sequences, and a guard time. The PRACH sequence is used by the TRP 102 for determining the carrier frequency offset (CFO) and the time delay (TD) between the TRP 102 and UE 114 for establishing the uplink synchronization therebetween.

If only a TD exists between the TRP 102 and UE 114, the TD may cause a cyclic shift of the ZC sequence of the PRACH preamble and consequently causes a cyclic shift for the peak of its cross/auto-correlation function by the same amount of shifting, which may be exploited to determine the TD. The determined TD may then be fed back to the UE 114 to use as time advance to establish an uplink time synchronization.

On the other hand, the existence of CFO may cause more complicated issues.

In 5G NR, the assigned cyclic prefix of a PRACH preamble is inversely proportional to the PRACH subcarrier spacing, which may only support a small cyclic prefix for a relatively large sub-carrier frequency spacing. For example, the frequency range 2 (FR2; referring to the millimeter-wave (mmWave) frequency bands from 24.25 GHz to 52.6 GHZ) PRACH formats in NR focus on the mmWave configuration which only requires a short propagation range. In contrast, the non-terrestrial TRP 102B requires a relatively massive propagation range and consequently a long cyclic prefix while at the same time using relatively large sub-carrier frequency spacing. Therefore, NR PRACH preamble formats may not support all non-terrestrial TRPs 102B as increasing PRACH subcarrier spacing proportionally decreases the length of the cyclic prefix. On the other hand, the product of CFO and differential TD may be significantly greater than 0.5, where the existing PRACHs in NR only support the value of 0.5 or less to ensure orthogonality and maintain the zero-correlation zone (ZCZ).

In 5G NR, several existing PRACH preamble formats may be used, which are all generated based on ZC sequences. As those skilled in the art understand, such PRACH preamble formats can capture CFOs less than the half of the PRACH sub-carrier spacing (known as the fractional CFO) and may be suitable for communication between terrestrial TRP 102A and UE 114 where the terrestrial TRP 102A is deployed at a fixed location.

The non-terrestrial TRPs 102B are often movable and some non-terrestrial TRPs 102B (such as low-earth satellites) may move at high speeds, which may result in large Doppler shifts represented by large CFOs in the received signals at the TRPs 102B. Such large CFOs are often several integer times of the PRACH sub-carrier spacing for non-terrestrial TRPs 102B. However, the existing PRACH preamble formats cannot capture a CFO greater than the half of the PRACH sub-carrier spacing.

The non-terrestrial TRPs 102B may experience both TD and integer CFO of the PRACH preamble. Herein, an integer CFO is a CFO that is an integer multiple of the PRACH sub-carrier spacing. In the current NR, it may be difficult to find both TD and integer CFO of the PRACH preamble because their existence may cause a mixed cyclic shift for the peak of the cross/auto-correlation function of the ZC sequences of the PRACH preamble.

While the existence of the fractional CFO of ZC sequence of the PRACH preamble may cause additional smaller peaks of its cross/auto-correlation function and at the same time cause a reduction in the magnitude of the cross/auto-correlation function true peak, the amount of such a reduction may be proportionally related to the level of the fractional CFO, which may be used to estimate the fractional CFO. However, the existence of both TD and integer CFO with/without a fractional frequency offset may cause multiple peaks in the ambiguity cross-correlation function (or simply the “ambiguity function”). FIG. 5 shows the ambiguity cross-correlation function when both TD and integer CFO exist. As can be seen, the multiple peaks in the ambiguity function may cause an uncertainty in identifying the true peak, thereby making it very complicated to extract both time advance and CFO. Consequently, the non-terrestrial TRP 102B may not be able to find the TD and integer CFO from a single measurement. This is a main impairment of PRACH preambles in NR.

In prior art, there are some methods to tackle this limitation of NR to solve the above-described issues in the PRACH of the non-terrestrial TRPs 102B. These methods may be grouped into two modes:
Concatenation mode: concatenating two or several ZC sequences using same or different roots; and
Superposition mode: using the superposition of two complex conjugate ZC sequences.

For example, one method is to use two ZC sequences in a concatenated mode using different time/frequency resources. The two sequences are complex conjugate to each other and are generated using the same root. Another method is to use two ZC sequences in a concatenated mode or in a superposition mode using the same time/frequency resources, where these two ZC sequences are generated using different roots and cannot be complex conjugate of each other. As an extension of this method, another method is to use several ZC sequences in a concatenated mode using different roots.

These prior-art methods may be categorized as:
Category 1: using a ZC sequence and its complex conjugate in a concatenated mode in different PRACH occasions; and
Category 2: using two or more ZC sequences that have different roots in the same or different PRACH occasions.

The main drawback of the prior-art methods of Category 1 is that a UE 114 cannot superpose the ZC sequence and its complex conjugate on the same PRACH resources, which may reduce the PRACH resource utilization and increase the transmission overheads. Moreover, the prior-art methods in Category 1 may lead to a detection ambiguity at the TRP 102 when two complex conjugate ZC sequences from different UEs 114 use the same PRACH resources. Thus, transmitting ZC sequence and its complex conjugate by a UE 114 on the same PRACH occasion leads to detection ambiguity at the TRP 102, which consequently prevents the TRP 102 from detecting the TD and CFO for the UE 114. Transmitting a ZC sequence and its complex conjugate by two UEs 114 of the same or different cell or beam, using the same time frequency resources, also leads to PRACH detection failure for those UEs.

In the prior-art methods of Category 2, using two or more ZC sequences with different roots for the same UE 114 reduces the available sequences for serving more UEs while ensuring orthogonality, or increases the level of inter-cell/inter-beam interference in the communication system 100, thereby increasing the number of used sequences to generate the PRACH, which also leads to increasing the complexity of the TRP receiver (especially when using more than two ZC sequences). Moreover, using the superposition of two complex conjugate ZC sequences may effectively result in a pure real non-ZC sequence.

According to one aspect of this disclosure, the communication system 100 uses a PRACH preamble having modified ZC sequences and related methods or procedures for uplink synchronization.

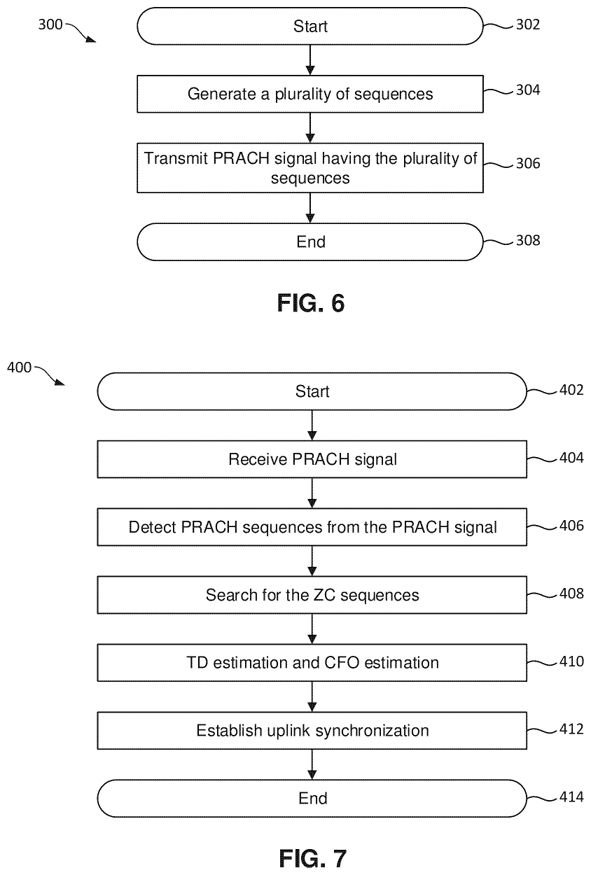

FIG. 6 is a flowchart showing a PRACH-signaling procedure 300 executed by a UE 114 for uplink PRACH preamble transmission, wherein the PRACH preamble comprises modified ZC sequences. When the procedure 300 starts (step 302), the UE 114 generates a plurality of sequences which comprise one or more ZC sequences and their scaled and rotated complex-conjugates (step 304).

As those skilled in the art understand, a ZC sequence is a sequence of complex values of a constant amplitude. Cyclically shifted versions of a ZC sequence are uncorrelated with each another.

A ZC sequence may be generated according to a mathematical formula. Such a generated ZC sequence is usually denoted by a root sequence for differentiating it from its cyclically shifted versions.

In some embodiments, the ZC sequence xᵤ[n] may be generated as

$${x}_{u} [ n ] = {e}^{- j \frac{π un ( n + 1 )}{{L}_{RA}}} \qquad ( 1 )$$

where L_{RA} is a prime number and u=1, 2, 3, . . . , L_{RA}−1. The complex conjugate of the ZC sequence xᵤ[n] is:

$${x}_{u}^{*} [ n ] = {e}^{j \frac{π un ( n + 1 )}{{L}_{RA}}} \qquad ( 2 )$$

where the superscript * represents complex conjugate. Those skilled in the art will appreciate that xᵤ*[n] can also be seen as x_{L}_{_{RA}}₋ᵤ[n]. In other words, the complex conjugate of a ZC sequence is also a ZC sequence of a different root.

Thus, at step 304 of the procedure 300, the UE 114 receives a rotation angle θ and a scaling factor R (1≥R>0) from the TRP 102 via radio resource control (RRC) signaling, and generates one or more ZC sequences xᵤ[n] and their scaled and rotated complex-conjugates Re^{jθ} xᵤ*[n].

The generated one or more ZC sequences xᵤ[n] and their scaled and rotated complex-conjugates Re^{jθ} xᵤ*[n] are then transmitted from the UE 114 to a TRP 102 (being the terrestrial TRP 102A or non-terrestrial TRP 102B) in the same or different PRACH occasions such as same or different time-frequency resources (step 306). The procedure 300 then ends (step 308).

The rotation angle θ introduces a new degree of freedom which helps in resolving multiple ambiguities and increases ZC roots available for PRACH for simultaneous transmissions from a plurality of UEs 114. Such a PRACH preamble, having modified ZC sequences, and the related PRACH-signaling procedure 300 enlarge the sequence design into multiple dimensions, which helps in resolving multiple ambiguities and enhances estimation accuracy. Accordingly, the TRP 102 may estimate the TD and/or CFO to ensure a proper uplink synchronization wherein the estimation accuracy may be improved by using two linearly independent measurements. Consequently, the TRP 102 may more accurately detect the integer and differential CFO.

Thus, the use of PRACH preambles having modified ZC sequences solves the problem of simultaneously estimating the TD and/or CFO in both terrestrial and non-terrestrial TRPs 102A and 102B to ensure a proper uplink synchronization. By properly selecting the scaling factor R, the PRACH preamble having modified ZC sequences and the PRACH-signaling procedure 300 provide backward compatibility with existing mobile wireless communication systems (such as NR systems), and provide a smooth transition from PRACH of TN systems (such as NR systems) to PRACH of NTN systems (such as 6G and/or other mobile wireless communication systems). Moreover, as compared to the prior-art methods of Category 1, the PRACH-signaling procedure 300 may additionally or alternatively use superposition on the same time and frequency resources for the ZC sequence and its rotated complex conjugate, and therefore provides various benefits such as:
The superposition mode is beneficial in terms of optimizing the number of PRACH occasions and reducing PRACH overhead.
In the concatenation mode, the PRACH-signaling procedure 300 allows two UEs 114 in the same or different cell/beam can use roots u and L_{RA}−u without creating detection ambiguity at gNB which is not the case for Category 2.

With the added degree of freedom, the PRACH-signaling procedure 300 efficiently utilizes either the same time/frequency or different time/frequency resources in PRACH signaling. Furthermore, the PRACH-signaling procedure 300 lowers implementation complexity.

As those skilled in the art understand, the prior-art Category-2 methods described above uses two ZC sequences with different roots u₁ and u₂. Consequently, the roots L_{RA}−u₁ and L_{RA}−u₂ may not be used by other UEs without creating detection ambiguity or PRACH failure. Moreover, using two different roots per preamble may create a complexity for the TRP 102 as the root pair selection needs to be optimized to avoid a negative impact to the detection performance.

On the other hand, the PRACH-signaling procedure 300 only uses a single root, thereby resulting in various benefits such as:
Simplicity in sequence generation and sequence detection at UE 114 and TRP 102 respectively;
Increasing the available number of preambles that can be allocated per UE, per cell.

In addition, the PRACH-signaling procedure 300 further provides a reduction of the peak-to-average power ratio (PAPR) of the used PRACH sequences as compared to prior-art methods.

FIG. 7 is a flowchart showing a PRACH-detection procedure 400 executed by a TRP 102 corresponding to the PRACH-signaling procedure 300.

When the procedure 400 starts (step 402), the TRP 102 receives the PRACH signal (step 404) and detects a plurality of PRACH sequences therefrom (step 406). At step 408, the TRP 102 searches for and determines ZC sequences corresponding to the PRACH sequences. Then, the TRP 102 estimates the TD and/or CFO based on the received PRACH signal and the determined ZC sequences using any suitable methods (step 410), and establishes uplink synchronization with the UE 114 based on the estimated TD and/or CFO (step 412), for example, by sending the estimated TD and/or CFO to the UE 114 such that the UE 114 may pre-compensate its transmitted signals by using the received TD and/or CFO. The procedure 400 then ends (step 414).

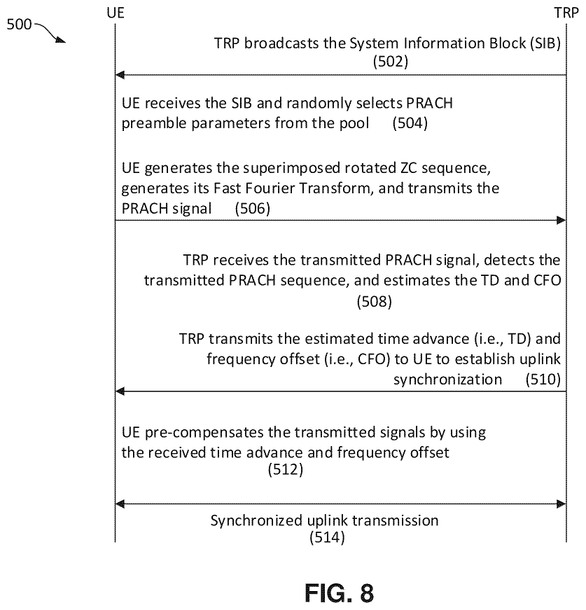

FIG. 8 is a diagram 500 showing the sequence of operations to establish the uplink synchronization between the UE 114 and the TRP 102 according to the PRACH-signaling procedure 300 and the PRACH-detection procedure 400.

In these embodiments, a plurality of ZC sequences have been generated according to formula (1) by applying a predetermined cyclic shift value N_{CS} and set type. The sequences are then stored as a pool or a set of PRACH preambles in, for example, the memory of the UE 114.

As shown in FIG. 8, the TRP first broadcasts the SIB (step 502). The UE 114 receives the SIB and selects PRACH preamble parameters from the pool (step 504). The UE 114 may, for example, randomly select the PRACH preamble parameters from the pool. At step 506, the UE 114 generates the superimposed rotated ZC sequence as described above, performs a time-domain to frequency-domain conversion operation, such as a Fast Fourier Transform (FFT), to generate the OFDM PRACH signal, and transmits the PRACH signal. At step 508, the TRP 102 receives the transmitted PRACH signal, detects the transmitted PRACH sequence, and estimates the TD and/or CFO. Then, the TRP 102 transmits the estimated TD and/or CFO to the UE 114 to establish uplink synchronization (step 510). At step 512, the UE 114 pre-compensates the transmitted signals by using the received TD and/or CFO. The synchronized uplink transmission is then established (step 514).

In the following, various embodiments of the procedures 300 and 400 are described.

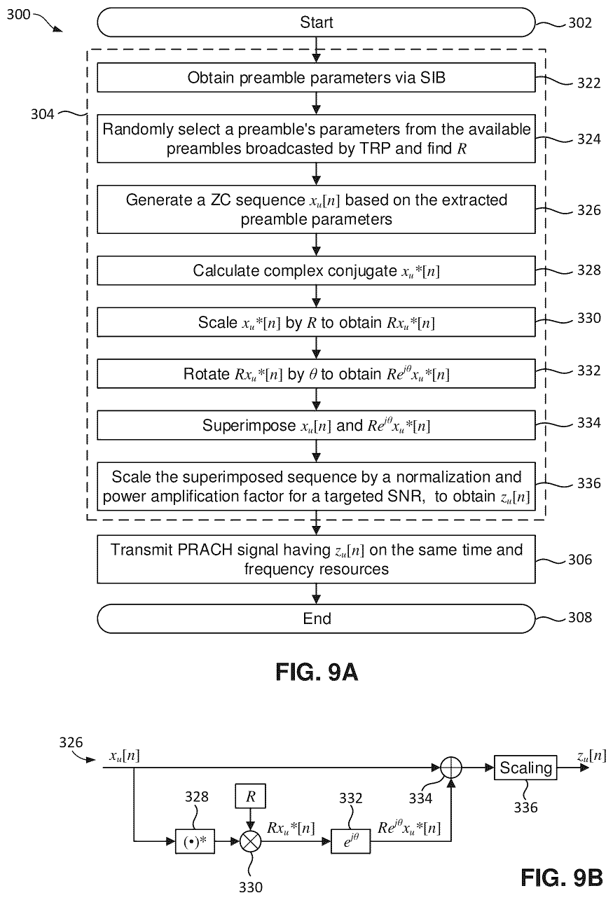

FIG. 9A is a flowchart showing the PRACH-signaling procedure 300 with the detail of the sequence-generation step 304 according to some embodiments of this disclosure. FIG. 9B is a flow diagram showing steps 326 to 336 of the PRACH-signaling procedure 300 shown in FIG. 9A.

At step 304 of the PRACH-signaling procedure 300, the UE 114 selects a ZC sequence (denoted xᵤ[n]) from the pool of PRACH preambles. The UE 114 may, for example, randomly select the ZC sequence from the pool. More specifically, at step 322, the UE 114 obtains preamble parameters from the system information block (SIB), and then selects (e.g., randomly selects) the parameters of a preamble from the available preambles broadcasted by the TRP 102 and determines the scaling factor R (step 324). Based on the selected preamble parameters, the UE 114 selects a ZC sequence xᵤ[n] from the pool of PRACH preambles (step 326).

Next, the complex conjugate xᵤ*[n] of the ZC sequence xᵤ[n] is calculated (step 328), which is then weighted by the scaling factor R and rotated by a rotation angle θ (steps 330 and 332; the order of which may be reversed) to obtain the scaled and rotated complex-conjugate Re^{jθ} xᵤ*[n] of the selected ZC sequence xᵤ[n]. The two sequences xᵤ[n] and Re^{jθ} xᵤ*[n] are then superimposed or otherwise summed together (step 334) and may be further scaled or weighted by a normalization and power amplification factor

$$γ = \frac{1}{\sqrt{1 + {R}^{2}}}$$

for a targeted signal-to-ratio (SNR) (step 336) to obtain a normalized superimposed sequence zᵤ[n]. Thus, zᵤ[n] may be written as:

$${z}_{u} [ n ] = γ ( {x}_{u} [ n ] + R {e}^{j θ} {x}_{u}^{*} [ n ] ) = \frac{1}{\sqrt{1 + {R}^{2}}} ( {x}_{u} [ n ] + R {e}^{j θ} {x}_{u}^{*} [ n ] ) \qquad ( 3 )$$

At step 306, the UE 114 transmits the normalized superimposed sequence zᵤ[n] to the TRP 102 on the same time and frequency resources.

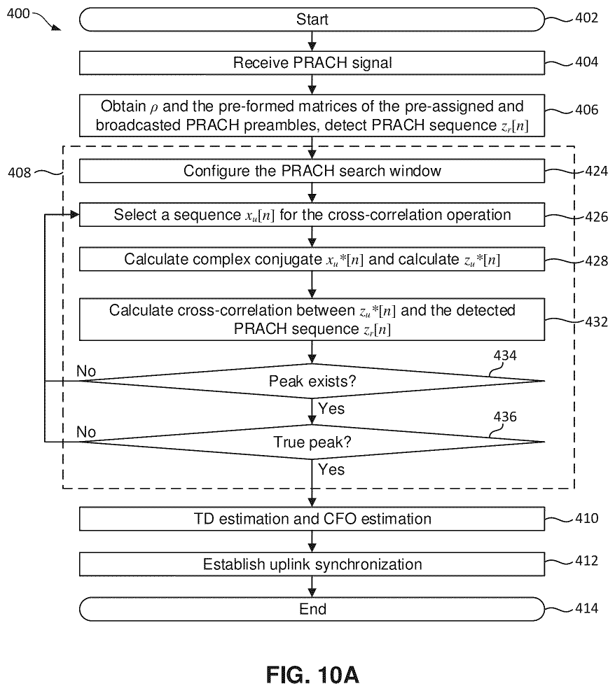

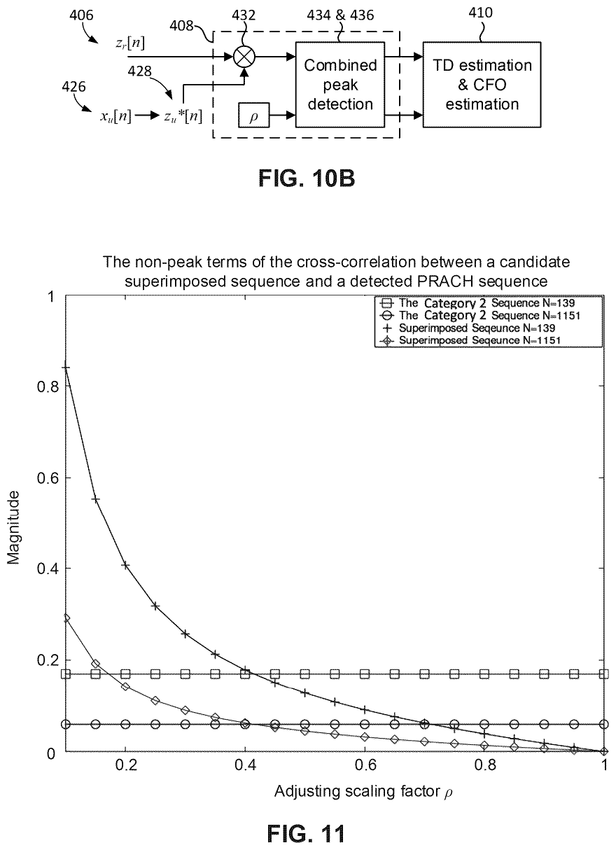

FIG. 10A is a flowchart showing the PRACH-detection procedure 400 corresponding to the PRACH-signaling procedure 300 shown in FIG. 9A. FIG. 10B is a flow diagram showing steps 406 to 410 of the PRACH-detection procedure 400 shown in FIG. 10A.

When the procedure 400 starts (step 402), the TRP 102 receives the PRACH signal (step 404). At step 406, the TRP 102 obtains an adjustment scaling factor ρ and pre-formed matrices of the pre-assigned and broadcasted PRACH preambles. The adjustment scaling factor ρ is used by the TRP 102 to adjust the peaks level, such that the adjustment scaling factor ρ may be initialized as equal to the parameter R used by the UE 114, and then adjusted or tuned during searching of peaks. Next, the TRP 102 detects a PRACH sequence, which is the received superimposed sequence zᵣ[n] (corresponding to the normalized superimposed sequence zᵤ[n] transmitted from the UE 114).

At step 408, the TRP 102 searches for and determines a ZC sequence xᵤ[n] corresponding to the PRACH sequence zᵣ[n].

More specifically, the TRP 102 configures the PRACH search window at step 424. Then, at step 426, the TRP 102 selects a candidate ZC sequence xᵤ[n] from a pool or a set of ZC sequences. At step 428, the TRP 102 calculates xᵤ*[n] and then calculates zᵤ*[n] (denoted a candidate superimposed sequence) which is the superimposed sequences xᵤ*[n] and ρe^{-jθ} xᵤ[n], that is:

$${z}_{u}^{*} [ n ] = {x}_{u}^{*} [ n ] + ρ {e}^{- j θ} {x}_{u} [ n ] \qquad ( 4 )$$

The TRP 102 uses a single correlator to calculate the cross-correlation between zᵤ*[n] and the detected PRACH sequence zᵣ[n] (step 432). The correlator output C_{z}_{ᵤᵣ}_{*}(n) may be expressed as:

$$\begin{matrix}{C}_{{z}_{ur}^{*}} ( n ) = \frac{1}{{L}_{R A}} {\sum }_{l = 0}^{{L}_{R A} - 1} {z}_{u} [ l ] {z}_{r}^{*} [ ( l - n ) ] \\ = \frac{1}{{L}_{R A}} {\sum }_{l = 0}^{{L}_{R A} - 1} γ ( {x}_{u} [ l ] + R {e}^{j θ} {x}_{u}^{*} [ l ] ) ( {x}_{u}^{*} [ ( l - n ) ] + ρ {e}^{- j θ} {x}_{u} [ ( l - n ) ] ) \\ = \frac{1}{{L}_{R A}} {\sum }_{l = 0}^{{L}_{R A} - 1} γ ( {x}_{u} [ l ] {x}_{u}^{*} [ ( l - n ) ] + ρ {e}^{- j θ} {x}_{u} [ l ] {x}_{u} [ ( l - n ) ] + R {e}^{j θ} {x}_{u}^{*} [ l ] {x}_{u}^{*} [ ( l - n ) ] + R ρ {x}_{u}^{*} [ l ] {x}_{u} [ ( l - n ) ] ) \\ = \frac{γ}{{L}_{R A}} {\sum }_{l = 0}^{{L}_{R A} - 1} {x}_{u} [ l ] {x}_{u}^{*} [ ( l - n ) ] + \frac{γ}{{L}_{R A}} {\sum }_{l = 0}^{{L}_{R A} - 1} R ρ {x}_{u}^{*} [ l ] {x}_{u} [ ( l - n ) ] + \frac{γ ρ {e}^{- j θ}}{\sqrt{{L}_{R A}}} + \frac{γ R {e}^{j θ}}{\sqrt{{L}_{R A}}}\end{matrix} \qquad ( 5 )$$

The two terms

$$\frac{γ ρ {e}^{- j θ}}{\sqrt{{L}_{R A}}} + \frac{γ R {e}^{j θ}}{\sqrt{{L}_{R A}}}$$

may cancel each other by tuning ρ, R, and θ such that

$$\frac{γ ρ {e}^{- j θ}}{\sqrt{{L}_{R A}}} = \frac{- γ R {e}^{j θ}}{\sqrt{{L}_{R A}}} ,$$

which may happen when ρ=R and θ=π/2, which leads to:

$${C}_{{z}_{ur}^{*}} ( n ) = \frac{γ}{{L}_{R A}} {\sum }_{l = 0}^{{L}_{R A} - 1} {x}_{u} [ l ] {x}_{u}^{*} [ ( l - n ) ] + \frac{γ {R}^{2}}{{L}_{R A}} {\sum }_{l = 0}^{{L}_{R A} - 1} {x}_{u}^{*} [ l ] {x}_{u} [ ( l - n ) ] \qquad ( 6 )$$

At step 434, the TRP 102 uses a correlation peak detection method to detect one or more true peaks in the calculated cross-correlation C_{z}_{ᵤᵣ}_{*}(n). In these embodiments, a true peak refers to a peak falling within the search window and greater than other cross-correlation values by at least a threshold value (for example, by at least a specific noise level).

More specifically, at step 434, the TRP 102 checks if any peak exists in the calculated cross-correlation C_{z}_{ᵤᵣ}_{*}(n). If no peak exists in the calculated cross-correlation, the procedure 400 goes back to step 426 to select another candidate ZC sequence xᵤ[n].

If at step 434, one or more peaks are detected, the TRP 102 then checks if any of the detected peaks is a true peak (step 436). If the detected peaks are not true peaks, the procedure 400 goes back to step 426 to select another candidate ZC sequence xᵤ[n]. Herein, the one or more true peaks are also denoted as one or more measurements. In the embodiments wherein a plurality of true peaks are detected, these true peaks or measurements are linearly independent from each other.

If at step 426, one or more true peaks are detected, the selected candidate ZC sequence is the ZC sequence used by the UE 114.

The TRP 102 then estimates the TD and/or CFO based on the selected ZC sequence xᵤ[n] and the detected PRACH sequence zᵣ[n] (step 410). More specifically, in some embodiments, the TRP 102 uses the detected one or more true peaks for estimating the TD and/or CFO.

For example, in some embodiments wherein the TRP 102 is a terrestrial TRP 102A, the CFO may be a differential CFO (which is a CFO less than half of the PRACH frequency spacing). Thus, the terrestrial TRP 102A in these embodiments may detect one true peak and use the detected true peak for estimating the TD. The differential CFO may be estimated based on the reduction level of the true peak's amplitude (that is, the amount of reduction determines the differential CFO).

In some other embodiments wherein the TRP 102 is a terrestrial TRP 102A, the terrestrial TRP 102A may detect two true peaks and use the detected true peaks for estimating the TD and CFO with improved accuracy.

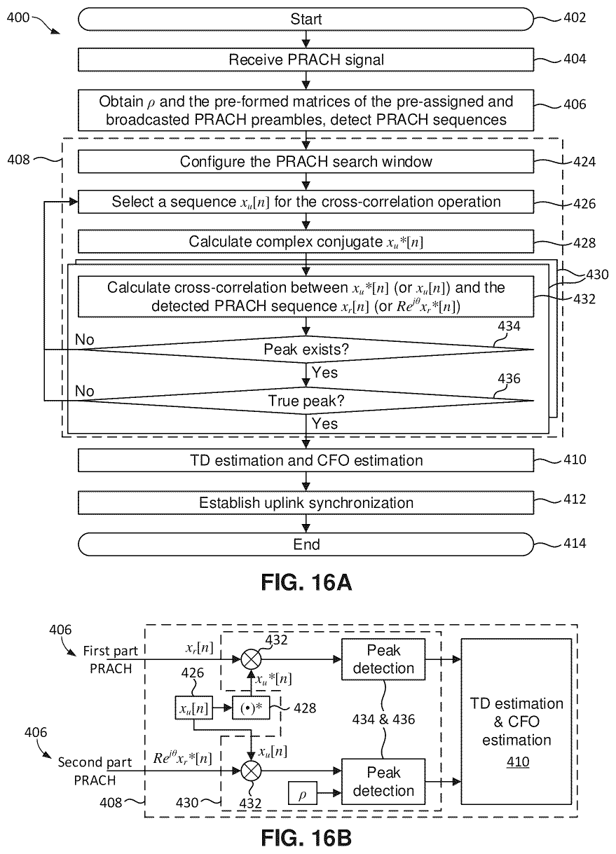

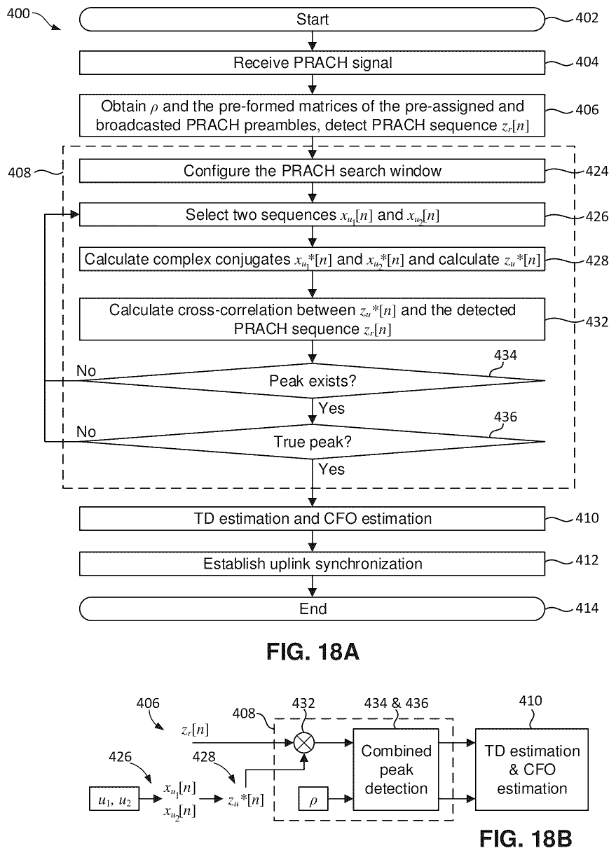

In yet some other embodiments wherein the TRP 102 is a non-terrestrial TRP 102B, the CFO may be either an integer CFO (which is an integer multiple of the PRACH frequency spacing) or a combination of integer and differential CFO. In these embodiments, the non-terrestrial TRP 102B may detect two or more true peaks using one correlator (for example, see FIG. 18B; to be described in more detail later) or a plurality of correlators in parallel (for example, see FIG. 16B; to be described in more detail later), and use the detected two or more true peaks for estimating the integer CFO and TD. As described above, the differential CFO may be estimated with an improved accuracy based on the reduction level of the true peaks' amplitudes.

After estimating the TD and/or CFO, the TRP 102 sends the estimated TD and/or CFO to the UE 114 and establishes uplink synchronization therewith (step 412). The procedure 400 then ends (step 414).

Those skilled in the art will appreciate that the cross-correlation C_{z}_{ᵤᵣ}_{*}(n) in these embodiments (see Equation (6)) may not have the terms

$$\frac{γ ρ {e}^{- j θ}}{\sqrt{{L}_{R A}}} + \frac{γ R {e}^{j θ}}{\sqrt{{L}_{R A}}}$$

when ρ=R and θ=π/2. As a comparison, the prior-art Category-2 methods do not have a rotation angle θ and a scaling factor R (and correspondingly, no scaling factor ρ). Thus, in the sequence used in the Category-2 methods, the cross-correlation has two terms

$$\frac{1}{\sqrt{{L}_{R A}}} + \frac{1}{\sqrt{{L}_{R A}}} ,$$

which lead to a constant term

$$\frac{2}{\sqrt{{L}_{R A}}}$$

that exists in any configuration. FIG. 11 shows the resultant magnitude of the two terms and how the variation of the scaling factor ρ of zᵤ[n] at the TRP 102 may change the resultant magnitude for two different lengths of superimposed sequences. FIG. 11 also compares the performance of using zᵤ[n] with the performance of using the sequence of the prior-art Category-2 method and illustrates the resultant magnitude of these arising terms at the correlator of the TRP 102. However, it is important to note that the prior-art Category-2 method needs to use two correlators with a more complicated structure of different ZC roots to perform the correlation operation.

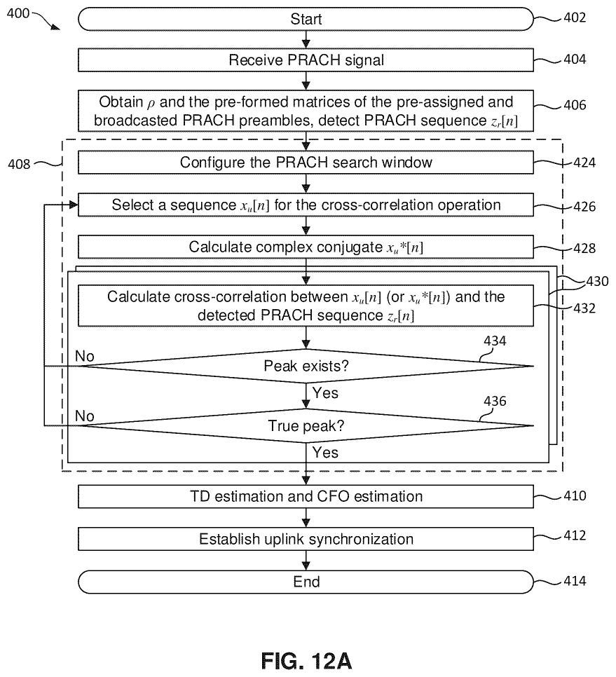

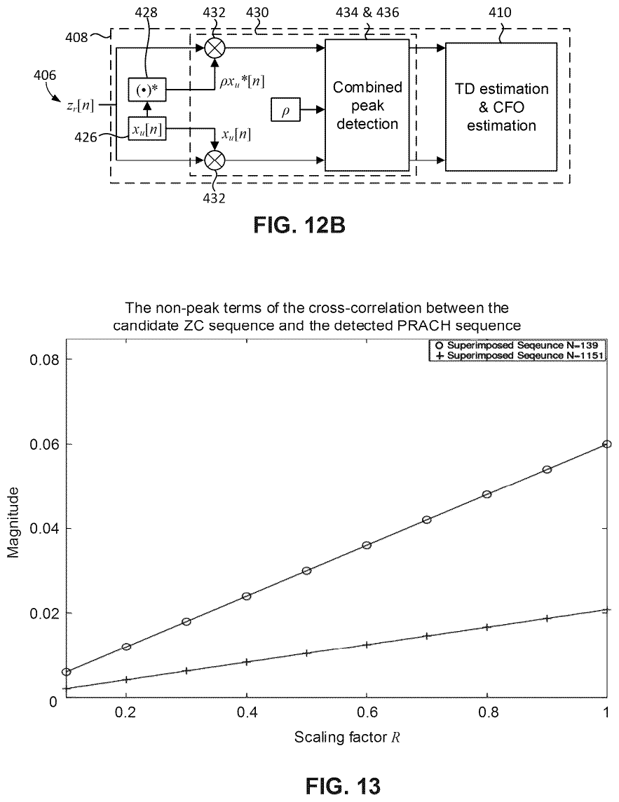

In the embodiments shown in FIGS. 10A and 10B, the TRP uses a single correlator to calculate the cross-correlation between zᵤ*[n] and the detected PRACH sequence zᵣ[n]. In some alternative embodiments as shown in FIGS. 12A and 12B, the TRP uses two correlators.

More specifically, steps 432 to 436 in these embodiments are performed for each of the xᵤ[n] and xᵤ*[n] (the operations therefor being represented by the box 430 in FIGS. 12A and 12B) to use two correlators to calculate the cross-correlations at step 432.

The first cross-correlation is between the candidate ZC sequence xᵤ[n] and the detected PRACH sequence zᵣ[n], which may be expressed as:

$$\begin{matrix}{C}_{{x}_{u}^{*}} ( n ) = \frac{1}{{L}_{R A}} {\sum }_{l = 0}^{{L}_{R A} - 1} {z}_{r} [ l ] {x}_{u}^{*} [ ( l - n ) ] \\ \frac{γ}{{L}_{R A}} {\sum }_{l = 0}^{{L}_{R A} - 1} ( {x}_{u} [ l ] + R {e}^{j θ} {x}_{u}^{*} [ l ] ) {x}_{u}^{*} [ ( l - n ) ] \\ \frac{γ}{{L}_{R A}} {\sum }_{l = 0}^{{L}_{R A} - 1} {x}_{u} [ l ] {x}_{u}^{*} [ ( l - n ) ] + \frac{γ}{{L}_{R A}} {\sum }_{l = 0}^{{L}_{R A} - 1} R {e}^{j θ} {x}_{u}^{*} [ l ] {x}_{u}^{*} [ ( l - n ) ] \\ \frac{1}{{L}_{R A}} {\sum }_{l = 0}^{{L}_{R A} - 1} {x}_{u} [ l ] {x}_{u}^{*} [ ( l - n ) ] + \frac{γ R {e}^{j θ}}{\sqrt{{L}_{R A}}}\end{matrix} \qquad ( 7 )$$

As the scaling factor R increases, the magnitude of the second term

$$\frac{γ R {e}^{j θ}}{\sqrt{{L}_{R A}}}$$

of Cₓ_{ᵤ}_{*}(n) increases, where it has an upper limit equal to

$$\frac{1}{\sqrt{2 {L}_{R A}}} .$$

FIG. 13 shows the magnitude of the second term

$$\frac{γ R {e}^{j θ}}{\sqrt{{L}_{R A}}}$$

with respect to different values of R for two different lengths of zᵣ[n] (which corresponds to zᵤ[n] on the UE side).

The second cross-correlation is between ρxᵤ*[n] and the detected PRACH sequence zᵣ[n], which may be expressed as:

$$\begin{matrix}{C}_{{x}_{u}} ( n ) = \frac{1}{{L}_{R A}} {\sum }_{l = 0}^{{L}_{R A} - 1} {z}_{r} [ l ] ρ {x}_{u} [ ( l - n ) ] \\ \frac{γ}{{L}_{R A}} {\sum }_{l = 0}^{{L}_{R A} - 1} ( {x}_{u} [ l ] + R {e}^{j θ} {x}_{u}^{*} [ l ] ) ρ {x}_{u} [ ( l - n ) ] \\ \frac{γ R ρ {e}^{j θ}}{{L}_{R A}} {\sum }_{l = 0}^{{L}_{R A} - 1} {x}_{u}^{*} [ l ] {x}_{u} [ ( l - n ) ] + \frac{γ ρ}{{L}_{R A}} {\sum }_{l = 0}^{{L}_{R A} - 1} {x}_{u} [ l ] {x}_{u} [ ( l - n ) ] \\ \frac{γ R ρ {e}^{j θ}}{{L}_{R A}} {\sum }_{l = 0}^{{L}_{R A} - 1} {x}_{u}^{*} [ l ] {x}_{u} [ ( l - n ) ] + \frac{γ ρ}{\sqrt{{L}_{R A}}}\end{matrix} \qquad ( 8 )$$

As the adjustment scaling factor ρ decreases, the magnitude of the second term

$$\frac{γ ρ}{\sqrt{{L}_{RA}}}$$

of Cₓ_{ᵤ}(n) decreases, where it has a lower limit equal to

$$\frac{1}{\sqrt{2 {L}_{R A}}} .$$

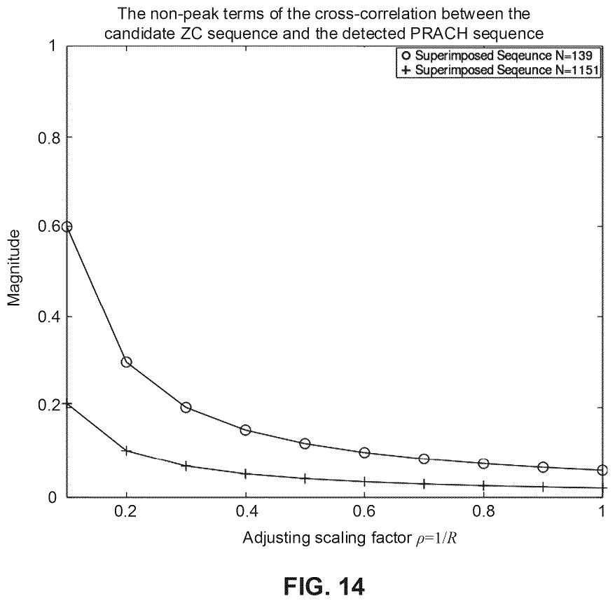

FIG. 14 shows the second term

$$\frac{γ ρ}{\sqrt{{L}_{RA}}}$$

with respect to various values of the adjustment scaling factor ρ for two different lengths of zᵣ[n] (which corresponds to zᵤ[n] on the UE side).

Referring back to FIGS. 12A and 12B, the TRP 102 checks if any peaks exist in the calculated cross-correlations (step 434), and if the peaks are true peaks (step 436). If either of the calculated cross-correlations does not have any true peak, then the procedure 400 goes back to step 426 to select another candidate ZC sequence xᵤ[n].

If both the cross-correlation of xᵤ[n] and the detected PRACH sequence zᵣ[n] and the cross-correlation of xᵤ*[n] and the detected PRACH sequence zᵣ[n] have one or more true peaks, the selected candidate ZC sequence is the ZC sequence used by the UE 114. The TRP 102 then estimates the TD and/or CFO based on the selected ZC sequence xᵤ[n] and the detected PRACH sequence zᵣ[n] as described above (step 410), and establishes uplink synchronization with the UE 114 (step 412). The procedure 400 then ends (step 414).

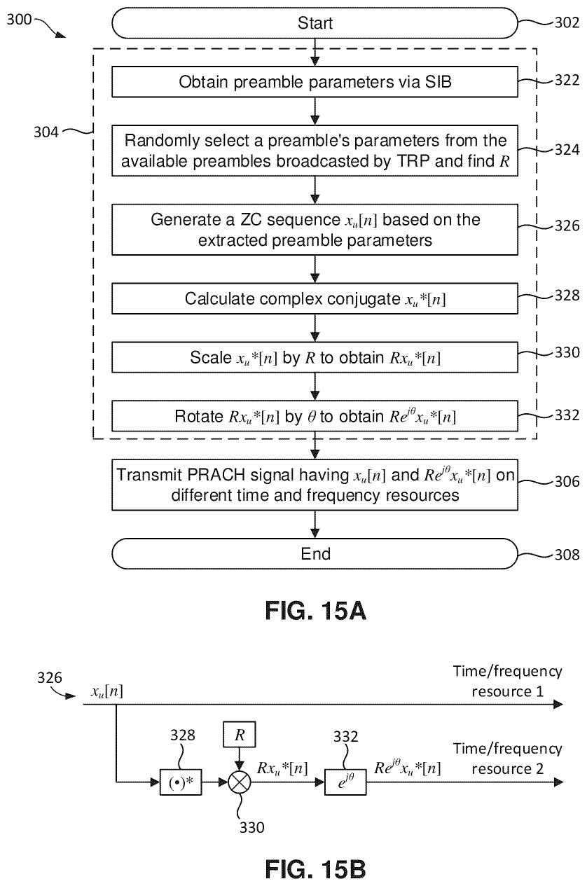

FIG. 15A is a flowchart showing the PRACH-signaling procedure 300 with the detail of the sequence-generation step 304 according to some embodiments of this disclosure. FIG. 15B is a flow diagram showing steps 326 to 336 of the flowchart shown in FIG. 15A.

The PRACH-signaling procedure 300 in these embodiments is similar to that shown in FIGS. 9A and 9B except that, in these embodiments, the two sequences xᵤ[n] and Re^{jθ} xᵤ*[n] are not superimposed to obtain the sequence zᵤ[n]. Rather, the UE 114 at step 306 transmits to the TRP 102 a PRACH signal having the two sequences xᵤ[n] and Re^{jθ} xᵤ*[n] on different time and frequency resources.

FIG. 16A is a flowchart showing the PRACH-detection procedure 400 corresponding to the PRACH-signaling procedure 300 shown in FIG. 15A. FIG. 16B is a flow diagram showing steps 406 to 410 of the flowchart shown in FIG. 16A.

When the procedure 400 starts (step 402), the TRP 102 receives the PRACH signal (step 404). At step 406, the TRP 102 obtains the scaling factor parameter p and the pre-formed matrices of the pre-assigned and broadcasted PRACH preambles. Next, the TRP 102 detects two PRACH sequences xᵣ[n] and yᵣ[n]=Re^{jθ} xᵣ*[n] (corresponding to the sequences xᵤ[n] and Re^{jθ} xᵤ*[n] transmitted from the UE 114).

At step 408, the TRP 102 searches for and determines a ZC sequence xᵤ[n] corresponding to the PRACH sequences xᵣ[n] and yᵣ[n].

More specifically, the TRP 102 configures the PRACH search window at step 424. Then, the TRP 102 selects a candidate ZC sequence xᵤ[n] from a pool or a set of ZC sequences (step 426) and calculates its complex conjugate xᵤ*[n] (step 428).

The TRP 102 calculates the cross-correlation between xᵤ*[n] and the detected PRACH sequence xᵣ[n] (step 432) and the cross-correlation between xᵤ[n] and the detected PRACH sequence yᵣ[n] (step 432), and checks if each of the calculated cross-correlations has any true peak (steps 434 and 436). If either of the calculated cross-correlations does not have any true peak, then the procedure 400 goes back to step 426 to select another candidate ZC sequence xᵤ[n].

If both calculated cross-correlations have one or more true peaks, the selected candidate ZC sequence is the ZC sequence used by the UE 114. The TRP 102 then estimates the TD and/or CFO based on the selected ZC sequence xᵤ[n] and the detected PRACH sequences xᵣ[n] and yᵣ[n] as described above (step 410), and establishes uplink synchronization with the UE 114 (step 412). The procedure 400 then ends (step 414).

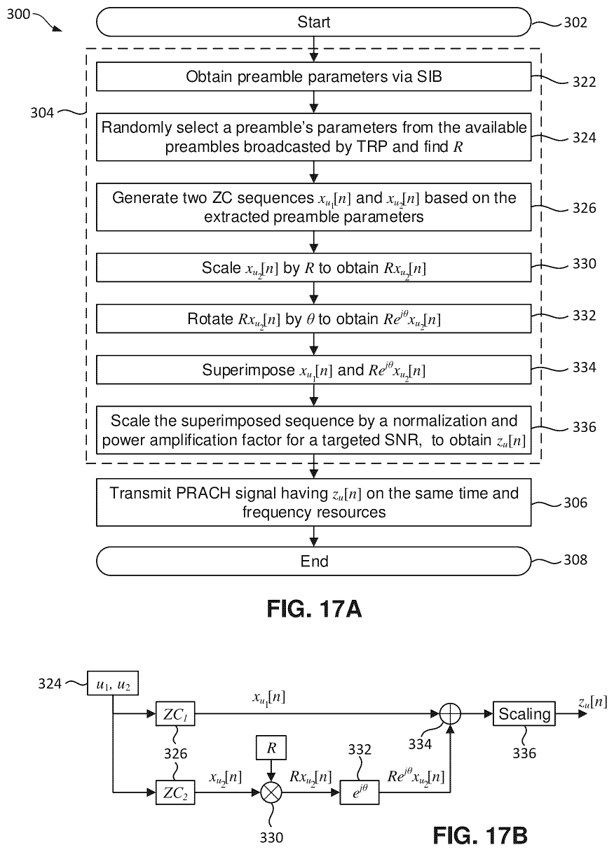

FIG. 17A is a flowchart showing the PRACH-signaling procedure 300 with the detail of the sequence-generation step 304 according to some embodiments of this disclosure. FIG. 17B is a flow diagram showing steps 326 to 336 of the flowchart shown in FIG. 17A.

In these embodiments, a plurality of ZC sequences have been generated according to formula (1) by applying a predetermined cyclic shift value N_{CS} and set type. The sequences are then stored as a pool of PRACH preambles in, for example, the memory of the UE 114.

At step 304 of the PRACH-signaling procedure 300, the UE 114 selects two ZC sequences (denoted xᵤ_{₁}[n] and xᵤ_{₂}[n]) from the pool of PRACH preambles. The UE 114 may, for example, randomly select the ZC sequences from the pool. More specifically, at step 322, the UE 114 obtains preamble parameters from the SIB, and then selects the parameters of a preamble from the available preambles broadcasted by the TRP 102 and determines the scaling factor R (step 324). The UE 114 may, for example, randomly select the parameters from the available preambles. The randomly selected parameters include two randomly selected ZC-sequence roots u₁ and u₂. Based on the selected preamble parameters, the UE 114 selects two ZC sequences xᵤ_{₁}[n] and xᵤ_{₂}[n] from the pool of PRACH preambles (step 326).

Then, the ZC sequence xᵤ_{₂}[n] is weighted by the scaling factor R and rotated by a rotation angle θ (steps 330 and 332; the order of which may be reversed) to obtain the scaled and rotated version Re^{jθ} xᵤ_{₂}[n] of the ZC sequence xᵤ_{₂}[n]. The two sequences xᵤ_{₁}[n] and Re^{jθ} xᵤ_{₂}[n] are then superimposed (step 334) and may be further scaled or weighted by a normalization and power amplification factor

$$γ = \frac{1}{\sqrt{1 + {R}^{2}}}$$

for a targeted SNR (step 336) to obtain a normalized superimposed sequence zᵤ[n]. Thus, zᵤ[n] may be written as:

$${z}_{u} [ n ] = γ ( {x}_{{u}_{1}} [ n ] + R {e}^{j θ} {x}_{{u}_{2}} [ n ] ) \qquad ( 9 )$$

At step 306, the UE 114 transmits the normalized superimposed sequence zᵤ[n] to the TRP 102 on the same time and frequency resources.

FIG. 18A is a flowchart showing the PRACH-detection procedure 400 corresponding to the PRACH-signaling procedure 300 shown in FIG. 17A. FIG. 18B is a flow diagram showing steps 406 to 410 of the flowchart shown in FIG. 18A.

When the procedure 400 starts (step 402), the TRP 102 receives the PRACH signal (step 404). At step 406, the TRP 102 obtains the scaling factor parameter p and the pre-formed matrices of the pre-assigned and broadcasted PRACH preambles. Next, the TRP 102 detects a PRACH sequence which is the received superimposed sequence zᵣ[n] (corresponding to the normalized superimposed sequence zᵤ[n] transmitted from the UE 114).

At step 408, the TRP 102 searches for and determines a pair of ZC sequences xᵤ_{₁}[n] and xᵤ_{₂}[n] corresponding to the PRACH sequence zᵣ[n].

More specifically, the TRP 102 configures the PRACH search window at step 424. Then, the TRP 102 selects two candidate ZC sequences xᵤ_{₁}[n] and xᵤ_{₂}[n] from a pool or a set of ZC sequences at step 426.

At step 428, the TRP 102 calculates the complex conjugates xx, [n] and xx, [n] and calculates zᵤ*[n] as:

$${z}_{u}^{*} [ n ] = {( {z}_{u} [ n ] )}^{*} = {x}_{{u}_{1}}^{*} [ n ] + ρ {e}^{- j θ} {x}_{{u}_{2}}^{*} [ n ] \qquad ( 10 )$$

The TRP 102 uses a single correlator to calculate the cross-correlation between zᵤ*[n] and the detected PRACH sequence zᵣ[n] (step 432). The correlator output C_{z}_{ᵤᵣ}_{*}(n) may be expressed as:

$${C}_{{z}_{ur}^{*}} ( n ) = \frac{γ}{{L}_{R A}} {\sum }_{l = 0}^{{L}_{R A} - 1} {x}_{{u}_{1}} [ l ] {x}_{{u}_{1}}^{*} [ ( l - n ) ] + \frac{γ}{{L}_{R A}} {\sum }_{l = 0}^{{L}_{R A} - 1} R ρ {x}_{{u}_{2}} [ l ] {x}_{{u}_{2}}^{*} [ ( l - n ) ] + \frac{γ ρ {e}^{- j θ}}{\sqrt{{L}_{R A}}} + \frac{γ R {e}^{j θ}}{\sqrt{{L}_{R A}}} \qquad ( 11 )$$

Similarly, the two terms

$$\frac{γ ρ {e}^{- j θ}}{\sqrt{{L}_{R A}}} + \frac{γ R {e}^{j θ}}{\sqrt{{L}_{R A}}}$$

may cancel each other when ρ=R and θ=π/2, and then:

$${C}_{{z}_{u τ}^{*}} ( n ) = \frac{γ}{{L}_{R A}} {\sum }_{l = 0}^{{L}_{R A} - 1} {x}_{{u}_{1}} [ l ] {x}_{{u}_{1}}^{*} [ ( l - n ) ] + \frac{γ {R}^{2}}{{L}_{R A}} {\sum }_{l = 0}^{{L}_{R A} - 1} {x}_{{u}_{2}} [ l ] {x}_{{u}_{2}}^{*} [ ( l - n ) ] \qquad ( 12 )$$

At step 434, the TRP 102 checks if any peak exists in the calculated cross-correlation (step 434). If no peak exists in the calculated cross-correlation, the procedure 400 goes back to step 426 to select another pair of candidate ZC sequences xᵤ_{₁}[n] and xᵤ_{₂}[n].

If at step 434, one or more peaks are detected, the TRP 102 then checks if any of the detected peaks is a true peak (step 436). If the detected peaks are not true peaks, the procedure 400 goes back to step 426 to select another pair of candidate ZC sequences xᵤ_{₁}[n] and xᵤ_{₂}[n].

If at step 426, one or more true peaks are detected, the selected candidate ZC sequences are the ZC sequences used by the UE 114. The TRP 102 then estimates the TD and/or CFO based on the selected ZC sequences xᵤ_{₁}[n] and xᵤ_{₂}[n] and the detected PRACH sequence zᵣ[n] as described above (step 410), and establishes uplink synchronization with the UE 114 (step 412). The procedure 400 then ends (step 414).

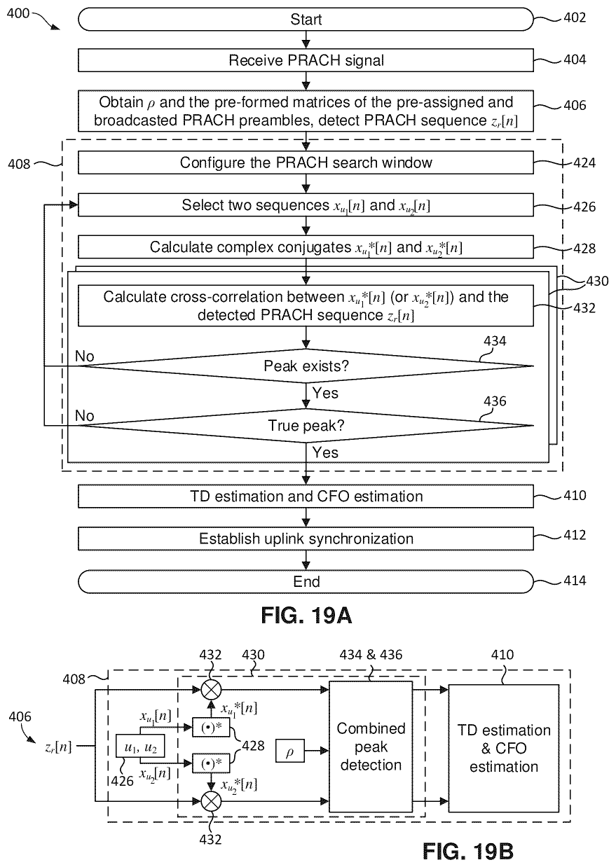

FIG. 19A is a flowchart showing the PRACH-detection procedure 400 corresponding to the PRACH-signaling procedure 300 shown in FIG. 17A. FIG. 19B is a flow diagram showing steps 406 to 410 of the flowchart shown in FIG. 19A.

When the procedure 400 starts (step 402), the TRP 102 receives the PRACH signal (step 404). At step 406, the TRP 102 obtains the scaling factor parameter p and the pre-formed matrices of the pre-assigned and broadcasted PRACH preambles. Next, the TRP 102 detects a PRACH sequence which is the received superimposed sequence zᵣ[n] (corresponding to the normalized superimposed sequence zᵤ[n] transmitted from the UE 114).

At step 408, the TRP 102 searches for and determines a pair of ZC sequences xᵤ_{₁}[n] and xᵤ_{₂}[n] corresponding to the PRACH sequence zᵣ[n].

More specifically, the TRP 102 configures the PRACH search window at step 424. Then, the TRP 102 selects two candidate ZC sequences xᵤ_{₁}[n] and xᵤ_{₂}[n] from a pool or a set of ZC sequences (step 426) and calculates their complex conjugates xᵤ_{₁}*[n] and xᵤ_{₂}*[n] (step 428).

For each of xᵤ_{₁}*[n] and xᵤ_{₂}*[n] (the operations thereof being represented by box 430), the TRP 102 calculates two cross-correlations.

The first cross-correlation is between xᵤ_{₁}[n] and the detected PRACH sequence zᵣ[n], which may be expressed as:

$${C}_{{x}_{u}^{*}} ( n ) = \frac{1}{{L}_{R A}} {\sum }_{l = 0}^{{L}_{R A} - 1} {x}_{{u}_{1}} [ l ] {x}_{{u}_{1}}^{*} [ ( l - n ) ] + \frac{γ R {e}^{j θ}}{\sqrt{{L}_{R A}}} \qquad ( 13 )$$

The second cross-correlation is between xᵤ_{₂}[n] and the detected PRACH sequence zᵣ[n], which may be expressed as:

$${C}_{{x}_{u}} ( n ) = \frac{γ R ρ {e}^{j θ}}{{L}_{R A}} {\sum }_{l = 0}^{{L}_{R A} - 1} {x}_{{u}_{2}} [ l ] {x}_{{u}_{2}}^{*} [ ( l - n ) ] + \frac{γ ρ}{\sqrt{{L}_{R A}}} \qquad ( 14 )$$

The TRP 102 then checks if any peak exists in the calculated cross-correlation (step 434). If no peak exists in the calculated cross-correlation, the procedure 400 goes back to step 426 to select another pair of candidate ZC sequences xᵤ_{₁}[n] and xᵤ_{₂}[n].

If at step 434, one or more peaks are detected, the TRP 102 then checks if any of the detected peaks is a true peak (step 436). If the detected peaks are not true peaks, the procedure 400 goes back to step 426 to select another pair of candidate ZC sequences xᵤ_{₁}[n] and xᵤ_{₂}[n].

If both cross-correlations have true peaks, the selected candidate ZC sequences are the ZC sequences used by the UE 114. The TRP 102 then estimates the TD and/or CFO based on the selected ZC sequences xᵤ_{₁}[n] and xᵤ_{₂}[n] and the detected PRACH sequence zᵣ[n] as described above (step 410), and establishes uplink synchronization with the UE 114 (step 412). The procedure 400 then ends (step 414).

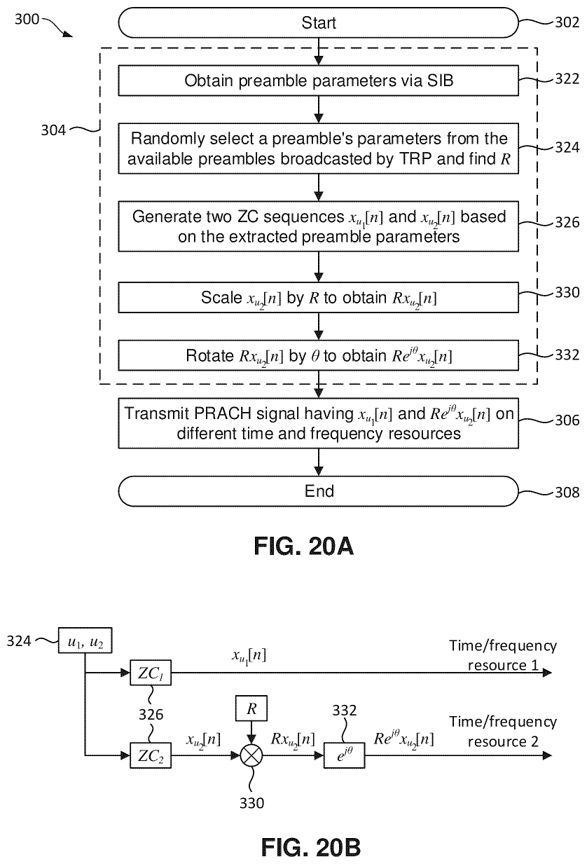

FIG. 20A is a flowchart showing the PRACH-signaling procedure 300 with the detail of the sequence-generation step 304 according to some embodiments of this disclosure. FIG. 20B is a flow diagram showing steps 326 to 336 of the flowchart shown in FIG. 20A.

In these embodiments, a plurality of ZC sequences have been generated according to formula (1) by applying a predetermined cyclic shift value N_{CS} and set type. The sequences are then stored as a pool of PRACH preambles in, for example, the memory of the UE 114.

At step 304 of the PRACH-signaling procedure 300, the UE 114 selects two ZC sequences (denoted xᵤ_{₁}[n] and xᵤ_{₂}[n]) from the pool of PRACH preambles. The UE 114 may, for example, randomly select the ZC sequences from the pool. More specifically, at step 322, the UE 114 obtains preamble parameters from the SIB, and then selects the parameters of a preamble from the available preambles broadcasted by the TRP 102 and determines the scaling factor R (step 324). The UE 114 may, for example, randomly select the parameters from the available preambles. The randomly selected parameters include two randomly selected ZC-sequence roots u₁ and u₂. Based on the selected preamble parameters, the UE 114 selects two ZC sequences xᵤ_{₁}[n] and xᵤ_{₂}[n] from the pool of PRACH preambles (step 326).

Then, the ZC sequence xᵤ_{₂}[n] is weighted by the scaling factor R and rotated by a rotation angle θ (steps 330 and 332; the order of which may be reversed) to obtain the scaled and rotated version Re^{jθ} xᵤ_{₂}[n] of the ZC sequence xᵤ_{₂}[n]. At step 306, the UE 114 transmits to the TRP 102 a PRACH signal having the two sequences xᵤ_{₁}[n] and Re^{jθ} xᵤ_{₂}[n] on different time and frequency resources.

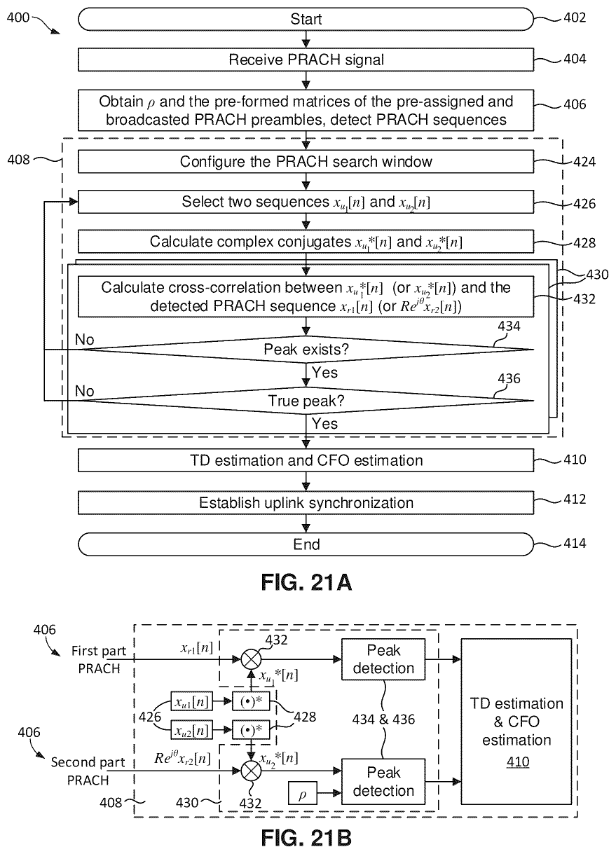

FIG. 21A is a flowchart showing the PRACH-detection procedure 400 corresponding to the PRACH-signaling procedure 300 shown in FIG. 20A. FIG. 21B is a flow diagram showing steps 406 to 410 of the flowchart shown in FIG. 21A.

When the procedure 400 starts (step 402), the TRP 102 receives the PRACH signal (step 404). At step 406, the TRP 102 obtains the scaling factor parameter p and the pre-formed matrices of the pre-assigned and broadcasted PRACH preambles. Next, the TRP 102 detects two PRACH sequences xᵣ₁[n] and yᵣ₂[n]=Re^{jθ} xᵣ₂[n] (corresponding to the sequences xᵤ_{₁}[n] and Re^{jθ} xᵤ_{₂}[n] transmitted from the UE 114).

At step 408, the TRP 102 searches for and determines a pair of ZC sequences xᵤ_{₁}[n] and xᵤ_{₂}[n] corresponding to the PRACH sequences xᵣ₁[n] and yᵣ₂[n].

More specifically, the TRP 102 configures the PRACH search window at step 424. Then, the TRP 102 selects two candidate ZC sequences xᵤ_{₁}[n] and xᵤ_{₂}[n] from a pool or a set of ZC sequences (step 426) and calculates their complex conjugates xᵤ_{₁}*[n] and yᵤ_{₂}*[n] (step 428).

For each of xᵤ_{₁}*[n] and xᵤ_{₂}*[n] (the operations thereof being represented by box 430), the TRP 102 calculates the cross-correlation between xᵤ_{₁}*[n] (or xᵤ_{₂}*[n]) and the detected PRACH sequence xᵣ₁[n] (or yᵣ₂[n]) (step 432), and checks if any peak exists in the calculated cross-correlation (step 434). If no peak exists in the calculated cross-correlation, the procedure 400 goes back to step 426 to select another pair of candidate ZC sequences xᵤ_{₁}[n] and xᵤ_{₂}[n].

If at step 434, one or more true peaks are detected, the TRP 102 then checks if any of the detected peaks is a true peak (step 436). If the detected peaks are not true peaks, the procedure 400 goes back to step 426 to select another pair of candidate ZC sequences xᵤ_{₁}[n] and xᵤ_{₂}[n].

If both cross-correlations have true peaks, the selected candidate ZC sequences are the ZC sequences used by the UE 114. The TRP 102 then estimates the TD and/or CFO based on the selected ZC sequences xᵤ_{₁}[n] and xᵤ_{₂}[n] and the detected PRACH sequence zᵣ[n] as described above (step 410), and establishes uplink synchronization with the UE 114 (step 412). The procedure 400 then ends (step 414).

In some embodiments, the modified sequence may be generated from a Zadoff-Chu (ZC) sequence rotated by an angle θ (that is, not scaled).

In some embodiments, the PRACH preamble may only comprise the modified sequence generated from a Zadoff-Chu (ZC) sequence rotated by an angle θ. Accordingly, the above-described PRACH-detection procedure 400 only uses one candidate ZC sequence in the search step 408.

In some embodiments wherein the communications environment suffers a large differential delay and a long cyclic prefix is needed, the PRACH-signaling procedure 300 may concatenate multiple copies of the zᵤ[n] sequence in a sequential (or aggregated) manner for accommodating the large differential delay.

The sequentially concatenated sequence S[n] may be generated as following:

$$S [ n ] = {\sum }_{d = 0}^{D} {z}_{u} [ n - d ( {N}_{u} + {N}_{CP}^{R A} + {N}_{G} ) ] \qquad ( 15 )$$

where zᵤ[n] is the superimposed sequence of xᵤ[n] and Re^{jθ} xᵤ*[n], Nu is the duration of the PRACH sequence, N_{CP}^{RA} is the cyclic-prefix duration of the PRACH preamble, NG is the guard-interval duration of the PRACH preamble (which may be only for TTD (FR-2)), and D is the number of concatenated copies of the zᵤ[n] sequence. D may be selected to ensure consistency that generated sequences work in both TN and NTN (or both terrestrial TRPs 102A and non-terrestrial TRPs 102B) as:

$$D = ⌈ \frac{{Delay}_{N T N}}{Maximum {Delay}_{T N}} ⌉ - 1 \qquad ( 16 )$$

where Delay_{NTN} is the TD of the non-terrestrial TRPs 102B or the TD of the NTN system, and Maximum Delay_{TN} is the maximum TD of the terrestrial TRPs 102A or the maximum TD of the TN system.

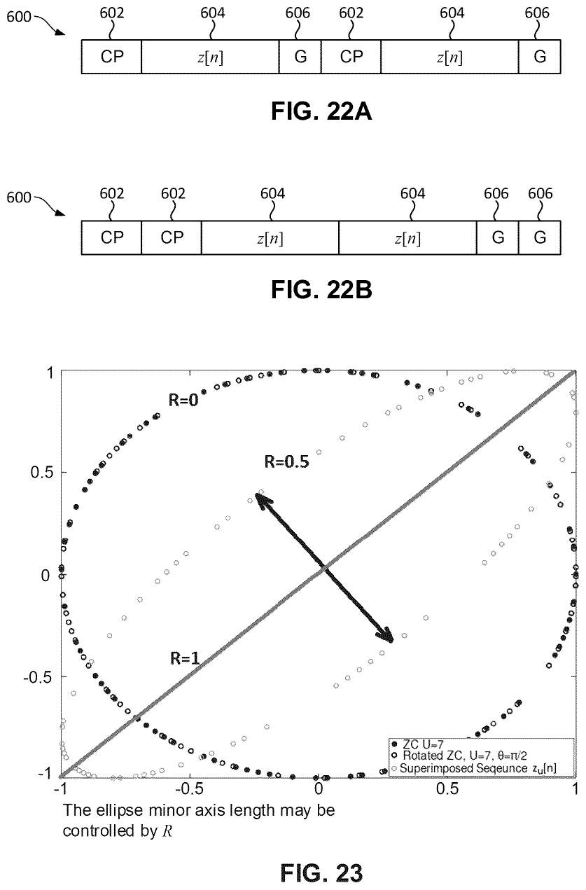

FIG. 22A shows the PRACH preamble 600 with the sequence S[n] formed by two copies of zᵤ[n] concatenated in the sequential manner, wherein CP represents the cyclic prefix 602, G represents the guard interval 606, and S[n] is the combination of the two copies of zᵤ[n] 604 which sandwich a guard interval 606 and a cyclic prefix 602.

FIG. 22B shows the PRACH preamble 600 with the sequence S[n] formed by two copies of zᵤ[n] concatenated in the aggregated manner. The PRACH preamble 600 in these embodiments comprises two aggregated cyclic prefix 602, two aggregated two copies of zᵤ[n] 604, and two aggregated guard intervals 606.

As those skilled in the art will appreciate, the above-described superimposed rotated PRACH sequence zᵤ[n] may be easily adopted in both TN systems and NTN systems (or terrestrial TRPs 102A and non-terrestrial TRPs 102B), and provides a backward compatibility with NR. In some embodiments, the above-described superimposed rotated PRACH sequence is tunable by adjusting the design parameters such as the rotation angle θ and the scaling factor R. In these embodiments, each UE 114 in the NTN system (or to communicate with a non-terrestrial TRP 102B) generates zᵤ[n] as a normalized PRACH sequence which in some embodiments is the normalized summation of a selected ZC sequence xᵤ[n] and the weighted and rotated complex-conjugate thereof, that is,

$${z}_{u} [ n ] = \frac{{x}_{u} [ n ] + R {e}^{j θ} {x}_{u}^{*} [ n ]}{\sqrt{{1}^{2} + {R}^{2}}} \qquad ( 17 )$$

or is the normalized summation of a first selected ZC sequence xᵤ_{₁}[n] and the weighted and rotated version of a second selected ZC sequence xᵤ_{₂}[n], that is,

$${z}_{u} [ n ] = \frac{{x}_{{u}_{1}} [ n ] + {e}^{j θ} R {x}_{{u}_{2}} [ n ]}{\sqrt{{1}^{2} + {R}^{2}}} \qquad ( 18 )$$

As described above, R is a design parameter used in both TN systems and NTN systems (or terrestrial TRPs 102A and non-terrestrial TRPs 102B), where 0<R<1. The optimal value of R in an NTN system (or a non-terrestrial TRP 102B) depends on the communications environment and configurations thereof. If the value of R=0, then, zᵤ[n]=xᵤ[n] or zᵤ[n]=xᵤ_{₁}[n], which is the ZC sequence in NR for TN systems, thereby providing the backward compatibility with NR while at the same time allowing its use in TN systems of 6G as TN systems only need a simple PRACH ZC sequence for estimating TD and fractional CFO.

As those skilled in the art will appreciate, the above-described PRACH preamble having modified ZC sequences and related PRACH-signaling and PRACH-detection procedures 300 and 400 require a low implementation complexity at the TRP 102, and require reduced computational resources for PRACH detection. In the embodiments as shown in FIGS. 12A-12B, 16A-16B, 19A-19B and 21A-21B, each correlator of the TRP 102 only requires one ZC sequence or its complex conjugate as an input. In the embodiments as shown in FIGS. 10A-10B and 18A-18B, the TRP 102 only requires a single correlator.

On the UE side, the above-described PRACH preamble having modified ZC sequences and related PRACH-signaling 300 provide a simplicity in generation of PRACH sequences. The above-described PRACH preamble having modified ZC sequences and related PRACH-signaling and procedure 300 also give rise to a reduced PAPR at the UE side, which may preserve the energy efficiency at UEs 114 and may reduce the cost of the UEs 114 as the UEs 114 may use low-cost amplifiers with reduced linear ranges.

The level of PAPR may be tuned by adjusting the rotation angle θ and/or the scaling factor R. For example, the PAPR of the PRACH signal increases as the value of the scaling factor R increases. Table 1 below shows the PAPR for various values of R, where the rotation angle θ is fixed and set to θ=π/2, L_{RA}=571, and u=7.

TABLE 1
the PAPR of zᵤ[n]

| R | PAPR of zᵤ[n] in dB |
|---|---|
| 0 | 0 |
| 0.1 | 1.8195 |
| 0.2 | 3.2801 |
| 0.3 | 4.4222 |
| 0.4 | 5.2913 |
| 0.5 | 5.9315 |
| 0.6 | 6.064 |
| 0.7 | 6.6875 |
| 0.8 | 6.8734 |
| 0.9 | 6.9707 |
| 1 | 6.9982 |

FIG. 23 shows how R affects the constellations of the entries of the superimposed sequence zᵤ[n] (having the ZC sequence xᵤ[n] and its rotated complex-conjugate e^{jθ} xᵤ*[n]) with comparison to the conventional ZC sequence xᵤ[n] and its rotated complex-conjugate e^{jθ} xᵤ*[n].

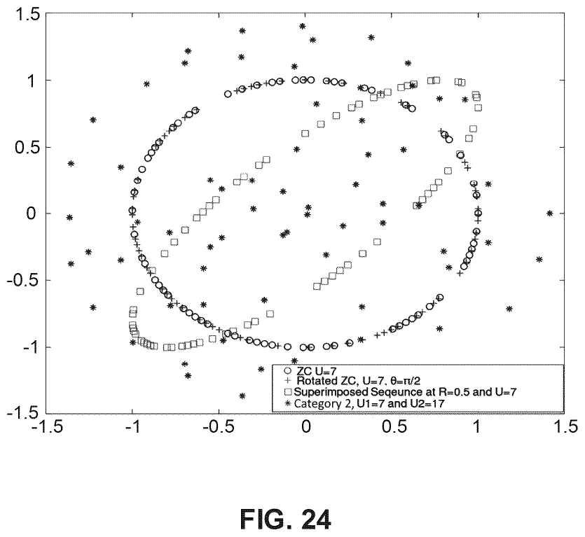

FIG. 24 shows the comparison of the constellations of the superimposed sequence zᵤ[n], conventional ZC sequence xᵤ[n], its rotated complex-conjugate e^{jθ} xᵤ*[n], and the prior-art method of Category 2 using two ZC sequences.

Table 2 and Table 3 below illustrate how the rotated angle θ may be tuned for a given ZC-sequence root that produces the minimum PAPR values of the corresponding superimposed sequence zᵤ[n] at a given value of the scaling factor R. The tables also show a comparison of the PAPR of the two of the generated sequences with the PAPR of another sequence that can be generated via one of the prior-art Category-2 methods. Moreover, as can be seen from Table 2, the methods disclosed herein provide a flexibility in assigning different ZC-sequence roots for the used sequences while achieving almost the same PAPR (which is lower than that of prior-art methods), thereby guaranteeing fairness to all served UEs 114.

TABLE 2
PAPR for various values of u with optimal θ, when
R = 1 and L_{RA} = 571

| | | | PAPR of the prior-art |
|---|---|---|---|
| | | PAPR (in dB) of zᵤ[n] | method of Category 2 |
| u | Optimal θ | in dB | using two ZC sequences |
| 17 | 180 | 6.5216 | 6.9061 |
| 61 | 15 | 6.5231 | |
| 7 | 0 | 6.5215 | 6.9291 |
| 11 | 180 | 6.5214 | |
| 5 | 0 | 6.5215 | 6.9292 |
| 9 | 0 | 6.5216 | |
| 6 | 90 | 6.5215 | 6.9383 |
| 18 | 270 | 6.5218 | |
| 55 | 195 | 6.5238 | 7.2073 |
| 110 | 285 | 6.5218 | |
| 37 | 0 | 6.5235 | 6.9291 |
| 41 | 180 | 6.5238 | |
| 67 | 15 | 6.5227 | 6.9292 |
| 71 | 15 | 6.5222 | |
| 20 | 270 | 6.5221 | 6.9084 |
| 60 | 105 | 6.5234 | |
| 271 | 225 | 6.5218 | 6.5214 |
| 277 | 225 | 6.5216 | |
| 250 | 315 | 6.5234 | 6.5432 |
| 500 | 345 | 6.5222 | |
| 300 | 135 | 6.5218 | 7.2437 |
| 271 | 225 | 6.5218 | |
| 200 | 120 | 6.5216 | 6.6388 |
| 199 | 210 | 6.5216 | |

TABLE 3
PAPR for various values of u with optimal θ,
when R = 0.5 and L_{RA} = 571

| | | | PAPR of the prior-art |
|---|---|---|---|
| | | PAPR (in dB) of zᵤ[n] | method of Category 2 |
| u | Optimal θ | in dB | using two ZC sequences |
| 17 | 180 | 5.5486 | 6.9061 |
| 61 | 15 | 5.5499 | |
| 7 | 0 | 5.5486 | 6.9291 |
| 11 | 180 | 5.5484 | |
| 5 | 0 | 5.5485 | 6.9292 |
| 9 | 0 | 5.5486 | |
| 6 | 90 | 5.5486 | 6.9383 |
| 18 | 270 | 5.5488 | |
| 55 | 195 | 5.5504 | 7.2073 |
| 110 | 285 | 5.5488 | |
| 37 | 0 | 5.5502 | 6.9291 |
| 41 | 180 | 5.5503 | |
| 67 | 15 | 5.5495 | 6.9292 |
| 71 | 15 | 5.5491 | |
| 20 | 270 | 5.549 | 6.9084 |
| 60 | 105 | 5.5501 | |
| 271 | 225 | 5.5488 | 6.5214 |
| 277 | 225 | 5.5486 | |
| 250 | 315 | 5.5501 | 6.5432 |
| 500 | 345 | 5.5491 | |
| 300 | 135 | 5.5488 | 7.2437 |
| 271 | 225 | 5.5488 | |
| 200 | 120 | 5.5487 | 6.6388 |
| 199 | 210 | 5.5486 | |

The above-described PRACH preamble having modified ZC sequences and related PRACH-signaling and PRACH-detection procedures 300 and 400 save frequency and time resources with significant improvement of resources utilizations, where the normalized superimposed PRACH sequence zᵤ[n] (see Equation (17)) may be sent on the same time and frequency resources. As a result, the above-described PRACH preamble having modified ZC sequences and related PRACH-signaling and PRACH-detection procedures 300 and 400 enable TRPs 102 to serve more UEs 114 simultaneously as the number of PRACH sequences per UE is minimized.

As the above-described PRACH preamble having modified ZC sequences is tunable, it may accommodate a wide range of implementation scenarios by modifying the rotation angle θ and the scaling factor R.

The superimposed sequence disclosed herein has a low level of the cross-correlation with its cyclically shifted versions in both cases of using a single correlator or two correlators. The technical features and benefits of above-described embodiments may include:
Providing at least two linearly independent measurements as the inputs of the estimator (or more than two linearly independent measurements when concatenation is used), which improves the estimation accuracy of TD and/or CFO;
Using a single root to generate the ZC sequence and its complex conjugate, which simplifies the receiver circuitry and PRACH detection at the TRP 102;
Enabling detection of large CFOs in various environments (such as up to half of the used PRACH bandwidth), which facilitates the establishment of uplink synchronization between the UE 114 and the TRP 102;
The design parameter R, wherein, when R=0, the above-described PRACH preamble having modified ZC sequences and related PRACH-signaling and PRACH-detection procedures 300 and 400 may operate for TN systems or the terrestrial TRPs 102A, which provides backward compatible with NR;
The tunable design parameters R and 0, which facilitate adapting of various communications environments;
Having a rotational angle that eliminates the ambiguity and adds an independency to the components of PRACH preamble, which may be used instead of using two non-complex conjugate PRACH preambles with different roots for the same UE 114, thereby giving the TRP 102 the capability to efficiently use the allocated PRACH preambles to simultaneously serve a large number of UEs 114, as the number of PRACH sequences per UE is minimized.
Providing an ability to control the PAPR at UEs 114 using R and θ to select the minimum optimal PAPR. At the TRP 102, the receiver thereof may only use one root to generate the ZC sequence with its complex conjugate and subsequently their cyclically shifted versions, which minimizes the number of correlation operations and consequently reduces the computational complexity, thereby improving the energy efficiency in both UEs 114 (through lowering the PAPRs) and at TRPs 102 (through lowered receiver complexity with a fast searching algorithm);
Option of transmitting the PRACH preamble using the PRACH sequence and its complex conjugate on same time and frequency resources with the capability to estimate TD and/or CFO, thereby preserving time/frequency resources and improving the PRACH occasions utilizations;
Having a concatenated sequential version either on the same or different PRACH occasions, thereby expanding the ability to accommodate multiple communications configurations and also ensuring orthogonality.

In above embodiments, the communication system 100 is a system combining terrestrial communication networks with non-terrestrial communication networks, such as combining cellular networks with satellite communication networks. In some embodiments, the terrestrial communication networks may comprise, or alternatively be, other radio access networks such as WI-FI® networks (WI-FI is a registered trademark of Wi-Fi Alliance, Austin, TX, USA).

### C. Acronym Key

4G: Fourth generation
5G: Fifth generation
6G: Sixth Generation
ASIC: Application Specific Integrated Circuit
BSC: Base Station Controller
CDMA: Code Division Multiple Access
CFO: Carrier Frequency Offset
CP: Cyclic Prefix
EDGE: Enhanced Data Rates for GSM Evolution
FDMA: Frequency Division Multiple Access
FFT: Fast Fourier Transform
FPGA: Field Programmable Gate Array
FR2: Frequency Range 2
GERAN: GSM EDGE Radio Access Network
GLONASS: Global'naya Navigatsionnaya Sputnikovaya Sistema
gNodeB or gNB: Next Generation Node of Base Station
GNSS: Global Navigation Satellite System
GPS: Global Positioning System
GSM: Global System for Mobile Communications
HAPS: High Altitude Platform Station
HSDPA: High Speed Downlink Packet Access
HSPA: High Speed Packet Access
HSUPA: High-Speed Uplink Packet Access
IRNSS: Indian Regional Navigation Satellite System
IoT: Internet-of-Things
IR: Infrared
LTE: Long-Term Evolution
MIMO: Multiple-Input Multiple-Output
mmWave: Millimeter-Wave
MTC: Machine Type Communication
NIC: Network Interface Controller
NR: New Radio
NTN: Non-Terrestrial Networks
OFDM: Orthogonal Frequency Division Multiplexing
OFDMA: Orthogonal Frequency Division Multiple Access
PAPR: Peak to Average Power Ratio
PDA: Personal Digital Assistant
POTS: Plain Old Telephone Service
PRACH: Physical Random-Access Channel
PSTN: Public Switched Telephone Network
QZSS: Quasi-Zenith Satellite System
RACH: Random-Access Channel
RAM: Random Access Memory
RAN: Radio Access Network
RF: Radio Frequency
RNC: Radio Network Controller
RNSS: Regional Navigation Satellite System
ROM: Read Only Memory
RRC: Radio Resource Control
RTD: Round-Trip Delay
SC-FDMA: Single-Carrier Frequency Division Multiple Access
SD: Secure Digital
SIB: System Information Block
SIM: Subscriber Identity Module
SNR: Signal-To-Noise Ratio
TD: Time Delay
TDMA: Time Division Multiple Access
TN: Terrestrial Networks
TRP: Transmit-Receive Point
UE: User Equipment
UMTS: Universal Mobile Telecommunication System
WCDMA: Wideband Code Division Multiple Access
WTRU: Wireless Transmit/Receive Unit
ZC Sequences: Zadoff-Chu sequences
ZCZ: Zero-Correlation Zone

### D. Definitions of Some Technical Terms

6th Generation: is the next generation of mobile networks that may combine both Terrestrial Networks and Non-Terrestrial Networks.

A sequence: is a vector that have multiple entries, the number of entries is known as the length of the sequences. The entries values are generally complex numbers.

Terrestrial Network: is the network that may be built on the ground either using wired connections or wireless connections. Each network node stands on the ground. Base stations are grounded base stations.

Non-Terrestrial Network: is the network that may be built using base stations that are flying on the air or in the space. It requires wireless connections and, in some cases, the flying base-station may be fed through a wired connection such as using a tethered drone. Base stations may be low earth-orbit (LEO) satellites, middle earth-orbit (MEO) satellites, high-altitude platforms stations (HAPS), unmanned aerial vehicles (UAV) platforms, drones, and/or the like.

Zadoff-Chu sequences: special type of sequences that have a unity magnitude of their entries, zero cross-correlation with their cyclic shifted versions, and constant cross-correlation with other Zadoff-Chu sequences that are generated using different roots.

Random Access Channel: is a shared channel that may be accessed randomly by multiple users either simultaneously or non-simultaneously.

Physical Random-Access Channel: is a physical-layer shared channel that may be accessed randomly by multiple users either simultaneously or non-simultaneously.

Round-Trip Delay: is the time required for the signal to propagate through the communication channel after originating the signal from the transmitter until the signal reach the receiver and then to propagate through the communication channel again from the receiver to come back to the original transmitter.

Carrier Frequency Offset: is the deviation that may happen on the frequency subcarriers due to the Doppler shift of the communication channel and due to the local oscillators' synchronization mismatching between the transmitter and the receiver.

Zero-Correlation Zone: is the zone where the cross-correlation of the cyclically shifted versions of Zadoff-Chu sequences are equal to zero.

Time Delay: is the difference between the starting time of the sequence at the transmitter and the starting time of the sequence at the receiver, which is induced by the communication channel due to the propagation time requirement for the signal to propagate from the transmitter to the receiver.

User Equipment: is the user equipment in the cellular communications network at both TN and NTN.

gNB: is the radio base station in 5G NR networks and is herein used to denote the radio base station of existing or future TN or NTN cellular network.

New Radio: refers to the 5G air interface between UE and gNB as specified by 3GPP.

Frequency Range (FR) 1, 2: FR1 refers to bands in the sub-6 GHz spectrum (although 7125 MHz is defined as the maximum) and FR2 refers to bands in the mmWave spectrum.

Peak to Average Power Ratio: is the quantity that equals to the maximum power of the signal divided by the average power of the signal.

Although embodiments have been described above with reference to the accompanying drawings, those of skill in the art will appreciate that variations and modifications may be made without departing from the scope thereof as defined by the appended claims.

1. A method comprising:
transmitting a random-access preamble comprising at least a modified sequence generated from a first Zadoff-Chu (ZC) sequence rotated by an angle, the first ZC sequence belonging to a set of ZC sequences.

2. The method of claim 1, wherein the modified sequence is the first ZC sequence rotated by the angle and scaled by a scaling factor.

3. The method of claim 1, wherein the random-access preamble further comprises a second ZC sequence.

4. The method of claim 3, wherein the first ZC sequence and the second ZC sequence are ZC sequences of different roots.

5. The method of claim 3, wherein the first ZC sequence is a complex conjugate of the second ZC sequence.

6. The method of claim 3, wherein the random-access preamble comprises a superimposed physical random-access channel (PRACH) sequence being a superimposition of the modified sequence and the second ZC sequence.

7. The method of claim 6, wherein the random-access preamble comprises a first copy and a second copy of the superimposed PRACH sequence; and
wherein a cyclic prefix (CP) is between the first copy and the second copy; or
wherein the second copy is directly concatenated to the first copy.

8. An apparatus comprising:
at least one processor coupled with a non-transitory computer-readable medium storing instructions, when the instructions are executed by the at least one processor, cause the apparatus to perform operations comprising:
receiving a random-access preamble;
determining from the random-access preamble at least a modified sequence, the modified sequence being a first Zadoff-Chu (ZC) sequence rotated by an angle, the first ZC sequence belonging to a set of ZC sequences; and
estimating at least one of a time delay (TD) or a carrier frequency offset (CFO) based on the random-access preamble and the modified sequence.

9. The apparatus of claim 8, wherein the modified sequence is the first ZC sequence rotated by the angle and scaled by a scaling factor.

10. The apparatus of claim 8, wherein the random-access preamble further comprises a second ZC sequence, and wherein the random-access preamble comprises a superimposed physical random-access channel (PRACH) sequence being a superimposition of the modified sequence and the second ZC sequence.

11. The apparatus of claim 10, wherein the determining from the random-access preamble at least the modified sequence comprises:
obtaining at least a candidate modified sequence based on the set of ZC sequences;
calculating a candidate PRACH sequence at least based on the candidate modified sequence;
calculating a cross-correlation between the candidate PRACH sequence and the superimposed PRACH sequence;
using correlation peak detection to detect one or more peaks of the cross-correlation greater than other values of the cross-correlation by at least a threshold value; and
determining the candidate modified sequence as the modified sequence.

12. The apparatus of claim 11, wherein the using the correlation peak detection comprises:
using the correlation peak detection to detect a peak of the cross-correlation greater than the other values of the cross-correlation by the at least threshold value; and
wherein the estimating the at least one of the TD or the CFO comprises:
estimating the TD based on the peak.

13. The apparatus of claim 11, wherein the using the correlation peak detection comprises:
using the correlation peak detection to detect a plurality of peaks of the cross-correlation greater than the other values of the cross-correlation by the at least threshold value; and
wherein the estimating the at least one of the TD or the CFO comprises:
estimating the TD and the CFO based on the plurality of peaks.

14. The apparatus of claim 10, wherein the determining from the random-access preamble at least the modified sequence comprises:
obtaining a candidate modified sequence and a second candidate ZC sequence based on the set of ZC sequences;
calculating a first cross-correlation between the superimposed PRACH sequence and the modified sequence;
calculating a second cross-correlation between the superimposed PRACH sequence and the second candidate ZC sequence; and
using correlation peak detection to detect one or more peaks of the first cross-correlation and the second cross-correlation respectively greater than other values of the first cross-correlation and the second cross-correlation by at least a threshold value; and
determining the candidate modified sequence and the second candidate ZC sequence as the modified sequence and the second ZC sequence, respectively.

15. An apparatus comprising:
at least one processor coupled with a non-transitory computer-readable medium storing instructions, when the instructions are executed by the at least one processor, cause the apparatus to perform operations comprising:
transmitting a random-access preamble comprising at least a modified sequence generated from a first Zadoff-Chu (ZC) sequence rotated by an angle, the first ZC sequence belonging to a set of ZC sequences.

16. The apparatus of claim 15, wherein the modified sequence is the first ZC sequence rotated by the angle and scaled by a scaling factor.

17. The apparatus of claim 15, wherein the random-access preamble further comprises a second ZC sequence.

18. The apparatus of claim 17, wherein the first ZC sequence and the second ZC sequence are ZC sequences of different roots.

19. The apparatus of claim 17, wherein the first ZC sequence is a complex conjugate of the second ZC sequence.

20. The apparatus of claim 17, wherein the random-access preamble comprises a superimposed physical random-access channel (PRACH) sequence being a superimposition of the modified sequence and the second ZC sequence.
